(19) United States
(12) Patent Application Publication
(10) Pub. No.: US 2011/0256515 A1
(43) Pub. Date: Oct. 20, 2011

(54) Sensitive Site Exploitation (SSE) & Forensic Collection (FC) Training Facility, System and Method

(75) Inventors: Sean M. Miller, Washington, DC (US); Donald L. Wenzlick, Leesburg, VA (US)

(73) Assignee: The Washington Security Group, Inc., Sterling, VA (US)

(21) Appl. No.: 12/910,001

(22) Filed: Oct. 22, 2010

Related U.S. Application Data
(60) Provisional application No. 61/254,096, filed on Oct. 22, 2009.

(51) Int. Cl. G09B 19/00; G09B 25/00

(52) U.S. Cl. 434/219; 434/365

(57) ABSTRACT

A system, method and facility for providing training, which may include basic, initial, developmental, intermediate, advanced, sustainment, training, mission rehearsals, exercises, annual events, missions, and practice scenarios, etc. Training may include props and reconfigurable scenarios simulating, e.g., a sensitive site exploitation (SSE) or forensic collection (FC) training scenario, etc. The method may include providing a reconfigurable training area which may be enclosed, in a building, or may be outdoors, or partially in and outdoors. The training area may provide a plurality of reconfigurable wall panels; and providing at least one moveable element in the reconfigurable training area. The training area may include providing an observation area for observing the training scenarios being conducted in the reconfigurable training area. The method may include providing an open, transparent, or one directionally transparent ceiling or wall to allow observation of the reconfigurable training area. An observation deck may be provided as part of the observation area for viewing the reconfigurable training area. Alternatively, the method may include one or more of: providing a display coupled to at least one of a stored video stream, or a live video stream from at least one camera in the reconfigurable training area.

### CROSS-REFERENCE TO RELATED APPLICATION

The present invention claims the benefit under 35 U.S.C. Section 119(e) of U.S. Patent Application Ser. No. 61/254,096, filed Oct. 22, 2009, entitled “Sensitive Site Exploitation (SSE) & Forensic Collection (FC) Training Facility, System and Method,” of common assignee to the present invention, the contents of which are incorporated herein by reference in their entireties.

### BACKGROUND OF THE INVENTION

1. Field of the Invention

The present invention relates generally to training systems and methods, more particularly to training systems and methods for armed forces, and even more particularly to training systems for armed forces relating to intelligence gathering.

2. Related Art

Sensitive Site Exploitation (SSE) is a relatively new discipline within armed forces disciplines of, e.g., the Armed Forces of the United States. While SSE has been discussed in theory for some time in the armed forces community, however, recent wars in Afghanistan and Iraq have shown the benefits of conducting a proper SSE operation and also the consequences of not conducting a proper SSE operation where missed intelligence and/or opportunities can be the difference between capturing a high value target (HVT), prosecuting captured enemy personnel, discovering potential attack plans on Coalition Forces, identifying enemy personnel conducting illegal or illicit activities, and confirming the presence of weapons of mass destruction (WMDs).

United States Army Special Text (ST) 3-90.15, Tactics, Techniques, and Procedures for Tactical Operations Involving Sensitive Sites, defines a “sensitive site” as: “A sensitive site is a geographically limited area with special diplomatic, informational, military, or economic sensitivity to the United States. Examples of sensitive sites include war crimes sites, critical hostile government facilities, areas suspected of containing persons of high rank in a hostile government, document storage areas for enemy classified files, or research and production facilities involving breakthrough technologies. Any place that contains or is suspected to contain, enemy research, production, storage, employment, use, or threat of use, of chemical, biological, radiological, and nuclear (CBRN) weapons is a sensitive site. These include areas, buildings, sites, or equipment that contain, or are suspected of containing, information, personnel, or equipment related to the proliferation of enemy CBRN capability.”

To prosecute sensitive site operations, in an exemplary embodiment, the U.S. Department of Defense (DoD) and the Intelligence Community (IC), for example, may conduct SSE operations. These operations are defined by the U.S. DoD and IC as “a related series of activities inside a captured sensitive site. These activities exploit personnel, documents, electronic data, and material captured at the site, while neutralizing any threat posed by the site or its contents.” In addition, these operations may exploit CBRN processes and can include sampling of signature and/or ongoing research, development, production, and/or weaponized product(s). In addition, traditional and emerging forensic collection may be exploited onsite including, e.g., but not limited to, DNA collection, latent fingerprints, gunshot and explosives residue, and collection and storage of biometric signatures, etc.

While these areas have conventionally been defined by a government, such as, e.g., but not limited to, the U.S. Government, the practical application in combat zones has come with varying degrees of success. Mediocre results are likely because: SSE is still an emerging discipline, SSE operations are often conducted in the stress of a combat zone, and because conventional SSE training programs have shortcomings and lack extensive practical exercises.

Conventional classroom training has lacked effectiveness. Conventional classroom training does not adequately prepare those conducting SSE operations. While SSE operations can occur in a variety of environments and against a variety of targets, conventional classroom training lacks such realism. SSE operations to exploit CBRN equipment, processes, facilities, and weapons are extremely high-risk. Effective SSE operations to include the exploitation of CBRN equipment and facilities require extensive initial and sustainment training to be effective. While the high-risk operations to exploit CBRN equipment serve as one part of SSE operations, these operations are extremely significant as WMDs have and continue to be, a threat to various nations including the United States and the potential use of WMDs is expected to be increasing. U.S.A.'s National Strategy to Combat Weapons of Mass Destruction states “[T]he gravest danger [the U.S.] faces lies at the crossroads of radicalism and technology. Our enemies have openly declared that they are seeking weapons of mass destruction, and evidence indicates that they are doing so with determination.”

Anthrax attacks against the United States in 2001 resulted in the deaths of five persons, injuries to dozens, and at least tens of millions of dollars spent in investigative cost. WMDs continue to be the ultimate weapon for radical extremists targeting countries, such as the United States. Leaders in the executive and legislative branches of government, including the U.S. Government, are realizing that another WMD attack on their countries, including the U.S., or its interests, is a harsh reality. In fact, a U.S. senate report entitled “The Lugar Survey on Proliferation Threats and Responses” states that a WMD attack occurring during the next decade is as high as 70% probability. In addition, the December 2008 Commission on the Prevention of Weapons of Mass Destruction reported that the Commission “unanimously agreed that it is more likely than not that a weapon of mass destruction will be used in a terrorist attack somewhere in the world by the end of 2013.” In response to the current threat, U.S.A., for example, implemented various policies including the National Strategy to Combat Weapons of Mass Destruction, the National Defense Strategy of the United States of America, the National Strategic Plan for the War on Terrorism, the National Military Strategy to Combat Weapons of Mass Destruction, and the National Intelligence Strategy of the United States of America. These policies call for increased security through proactive measures including counterproliferation, non-proliferation, and consequence management. They require action from federal, state, and local organizations and oftentimes support from industry and academia with a spotlight on improvements for training first responders in domestic scenarios plus increasing the readiness of Department of Defense (DoD) and Intelligence Community (IC) assets.

While individual services such as the U.S. Army and the U.S. Marine Corps have policies; field manuals; special text; and general tactics, techniques, and procedures related to SSE operations, they lack complete formal SSE training programs, facilities, and equipment. DoD WMD training efforts have traditionally been focused on protecting personnel on the battlefield. Conventional training includes the proper use of personal protective equipment and basic detectors—only requiring minimal infrastructure to accomplish tactical goals in a “traditional” training environment. Both the DoD and the IC are being tasked with roles and missions more sophisticated than ever before. These new tasks are due to an increased focus on non-state actors as a primary threat, as well as an increase in science and technology involving non-traditional chemical warfare agents, antibiotic-resistant bacterial weapons, and the introduction of non-state actors working independently of, or with the covert backing of, a state sponsor, coupled with ever-sophisticated CBRN equipment, detection and forensic science technologies, tools, and procedures.

Moreover, DoD or IC owned and/or occupied/leased facilities for SSE training have a range of shortcomings. The primary shortcoming is that DoD/IC facilities have static targets/training areas where the floor plans and equipment remain the same over long periods of time. This imparts problems for the student/exercise participant as they do not encounter a realistic scenario. A real world operation would vary over time and from place-to-place. What is needed is a more varying experience with non-static floor plans, equipment, and props serving to provide both the individual and team with new experiences and challenges. The static nature of conventional training presents long-term issues related to team competence and ability to deal with the unknown, since military/government personnel may prosecute the same permanent/static target/training area a significant number of times over the course of their career, if trained under conventional methods.

Another major shortcoming of conventional training facilities is that DoD/IC targets/training areas are only designed and developed to train, test, and evaluate personnel on collection and exploitation for that individual sensitive site location. The conventional training approach incorrectly imbues the narrow mindset that the students are only at a site to sample or collect material without regard to other outside factors. State and non-state actor programs, generally do not occur in isolation or even at one facility/location. A real world site/location generally requires supply and logistics support, import/export operations, finance and banking which may include money laundering, various levels of technical expertise, and a multitude of personnel. Conventional training approaches, and infrastructure design, promote individual targets with their isolated exploitation as the priority, and the related programmatic components as a secondary effort. Thus, conventional training fails to include the enemy program as a priority, and further complicates by failing to provide an understanding of the enemy program. Such enemy programs are often complete with multiple, and in many cases an unknown number of, related and supporting entities. Targets/training areas that are developed in the traditional conventional manner lack context and oftentimes lead to missed intelligence and missed tactical/collection opportunities.

Additional shortfalls in DoD/IC training infrastructure are related to the equipment provided and used in training against these complex problem sets. In many cases, organizations, agencies, and units do not have internal equipment to conduct initial, developmental, intermediate, advanced or sustainment training, mission rehearsals, certification training, and exercises. In cases where organizations do have dedicated training infrastructure, to include Chemical, Biological, Radiological, Nuclear, and Explosives (CBRNE) equipment, there is a lack of complete process and significant gaps in showing a comprehensive scale-up process in making CBRNE.

While SSE is a term used by military organizations, including the DoD and foreign military organizations, its civilian law enforcement counterpart is forensic collection/crime scene investigation and there are clear areas where SSE and forensic/crime scene investigation overlap. Of note is that law enforcement agencies also have many shortcomings for domestic operations in support of federal, state, and local level efforts to prevent the use of WMD and to investigate and/or exploit CBRNE equipment, processes, facilities, and weapons. In many cases, domestic law enforcement personnel serve as the last line of defense against an attack. The overwhelming majority of the focus of domestic law enforcement personnel has been on how to respond to an attack, to protect the law enforcement personnel, to preserve the crime scene (attack site), to conduct crowd control, and to render basic emergency medical treatment. Similarly to the case of conventional military units, law enforcement personnel are merely trained in the proper use of personal protective equipment and basic detectors—which requires minimal infrastructure. The domestic Anthrax attacks in 2001, showed that it is possible for an individual to produce a weapons grade biological agent in a country such as the United States, using equipment available entirely in the United States. Therefore, it is plausible that a weapon could be researched, developed, produced, weaponized, and delivered to its intended target(s) entirely within a given country, such as, e.g., the United States. Therefore, what is needed for effective law enforcement, is a capability to exploit and conduct specialized crime scene investigations of suspected CBRNE facilities both prior to an attack, and after an attack has occurred. Conventional training facilities fail to provide such features. For example, the majority of past and current law enforcement efforts on illicit drug laboratories merely include an intense focus on methamphetamine and marijuana, a very narrow view of the drug problem. Federal law enforcement organizations, chartered with counterproliferation missions, do receive basic hazardous materials (HAZMAT) training and, in some cases, follow-on CBRNE specific training including only sampling and collection. However, such conventional federal law enforcement organization training efforts fail to include comprehensive, integrated training and mission preparation facilities. They also lack the equipment necessary to develop complex and diverse targets/training areas for initial or ongoing training and exercises.

Governments, such as, e.g., the U.S. government, have turned to industry and academia groups to support their requirements due to the lack of SSE training and mission preparation infrastructure within government agencies and units. The use of industry or academia is especially true with regards to SSE operations requiring CBRNE and forensic knowledge, skills, and abilities. Commercial laboratories and research centers are natural venues for such training and preparation, based on the existing laboratory infrastructure. This has, however, proved to be minimally successful. The primary reasons include safety concerns due to ongoing chemical/biological activities (e.g., dangers of mishandling of dangerous agents) as well as security concerns, as many organizations are engaged in proprietary research to develop a commercial product in a competitive market, hindering access to realworld environments. Another drawback to existing laboratories is their static nature, the fact that such real world laboratories are fixed/permanent in nature—the equipment does not change (or changes infrequently) and the laboratory layout remains the same over time. Further, ongoing operations in existing laboratories oftentimes create scheduling and access issues because the laboratory personnel are concerned about a loss of research/productivity related to training time. Conventional academic institutions and corporate entities have similar problems with safety, security, equipment, and the permanent nature of their facilities. As a result, personnel and teams cannot gain sufficient experience or professional growth to effectively prepare them for real world SSE operations in general, and CBRNE exploitation operations and/or forensic collection specifically.

Conventional training approaches, across all groups, have common deficits including: a) lack of infrastructure (either no facilities, or at best, static facilities), b) lack of sufficient/functional equipment (to demonstrate at the basic level a complete terrorist safehouse to the advanced level of a complete process from research through various scale-up processes of WMD), and c) including at most a minimalistic hazardous materials and sampling approach (lacking a robust operational and intelligence collection approach which would include sampling in a hazardous environment).

As required by the National Defense Authorization Act, the Counterproliferation Program Review Committee (CPRC) conducts an annual review of interagency activities and programs for countering proliferation and Nuclear, Biological, and Chemical (NBC) terrorism. Each year, normally in the spring or early summer, the CPRC submits a mandatory report to Congress. In 2006, the CPRC began publishing shortfalls and recommendations for improvements. Every year since, the CPRC has listed as a shortfall that the U.S. Government has a “lack of capabilities and procedures to secure and exploit WMD sites.” In addition, the report has for the last four years recommended that the U.S. Government “improve capability to conduct exploitation of WMD sites, including characterization of local WMD, onsite analysis, and data infiltration.” When you couple the CPRC findings and the above identified shortcomings, you can understand that countries' armed forces, including the U.S. forces/agencies, have a lessened operational capability to defend against a WMD attack than the countries should have. This, therefore, provides a tactical advantage to those persons, groups, or states with the intention of employing WMD against a given targeted country.

What is needed then is to help a country's armed forces and agencies counter the proliferation threat by providing an integrated Sensitive Site Exploitation (SSE) & Forensic Collection Training (FCT) facility that overcomes shortcomings of conventional training facilities.

### SUMMARY OF THE INVENTION

An exemplary embodiment of the present invention is directed to a training system, method and related facilities and apparatuses for providing training to, e.g, armed forces, etc., such as, e.g., but not limited to, the Armed Forces of the United States of America, including defense agencies such as, e.g., but not limited to, combat support agencies, the intelligence community (IC), and law enforcement personnel and teams chartered with conducting sensitive site exploitation (SSE) operations and/or operations to collect intelligence and/or forensic collection (FC) and/or forensic evidence. An exemplary embodiment of the present invention is directed to an integrated SSE and/or FC training facility.

According to an exemplary embodiment of the present invention, an improved SSE and/or FC training facility may include a complete system, method and apparatuses, for providing, in an exemplary embodiment, a reconfigurable training and mission rehearsal area, necessary equipment and supplies, and supporting training rooms and infrastructure.

In an exemplary embodiment, the SSE and/or FC training facility may include, a complete system which may include, e.g., but not limited to, capabilities which may include, e.g., but are not limited to, a reconfigurable training and mission rehearsal area, a skills development area, an equipment supply and logistics area, a training/exercise participant staging and preparation area, a specialized lecture facility, and a training support area, which, in an exemplary embodiment, may include a training/exercise briefing and debriefing area.

In an exemplary embodiment of the present invention, a sensitive site exploitation (SSE) and/or forensic collection (FC) training facility is disclosed. Various exemplary, but non-limiting embodiments are contemplated and set forth, but should not be thought to limit the invention set forth in the claims.

According to an exemplary embodiment of the present invention, a first aspect of the invention may include, an exemplary facility, which may include, e.g., but not limited to, one or more training and training support areas. According to an exemplary embodiment, training areas may include, e.g., but not limited to, in combination at a single location, training areas for pre-training, training, and/or post-training activities. In an exemplary embodiment, training areas may include, e.g., but not limited to, areas for planning, gear and equipment storage, briefing, training and mission preparation activities, observation and evaluation, post-mission briefing, and/or post-mission recovery.

Training may include, e.g., but not limited to, basic training, initial training, intermediate training, advanced training, sustainment training, mission rehearsal training, exercises training, annual or periodic events training, mission exercise training, practice training, certifications, etc.

In one exemplary aspect, the training facility may include a reconfigurable training area. In one exemplary embodiment, the training facility may include an observation area. In an exemplary embodiment, the reconfigurable training area may be used to conduct a training scenario, and in an exemplary embodiment may include a plurality of walls, which in an exemplary embodiment may form a box structure, which in an exemplary embodiment may be a permanent box structure, which, in an exemplary embodiment, may accept walls and/or equipment that may be adapted for easy movement, may be completely mobile, and/or moveable into a variety of configurations.

In an exemplary embodiment, the training area may be in an enclosed building, or partially within an enclosed building, warehouse, office building, etc. The training area may be partially indoor and/or partially outdoor. In one exemplary embodiment, there may be included an inner city block, one or more buildings, a driver track, a firearms range, etc. The training area may include, e.g., but not limited to, any of various props, which may include, e.g., scientific equipment, etc.

In another exemplary aspect, the exemplary walls may be moveable, and may be of various styles and sizes to allow for a multitude of configurations within and outside the box structure. An exemplary embodiment may also include securing the walls to the external box walls and a given wall to another given wall, for stability and safety. Once complete, the walls may appear to be normal residential, and/or commercial facility walls.

In another exemplary aspect, large equipment and furnishings may be modified with wheels, coasters, and/or skids to facilitate easy movement throughout the facility. The modifications to facilitate movement may allow for, e.g., but not limited to, a small cadre of facility workers to completely move normally non-mobile laboratory equipment into and out of various scenarios, as necessary, or desired, to conduct training and mission preparation.

In another exemplary aspect, the training area may be observable from an observation area, which in exemplary embodiments may be an observation deck, an overhead deck, a catwalk, and/or a room overlooking the training area or displaying on one or more display devices, e.g., but not limited to, video and/or audio of the training scenarios via audio and/or video equipment and networking/wiring/cabling and/or storage and playback equipment and/or computer systems. In an exemplary embodiment, the observation area may be overhead, may be an observation deck, may be a metallic catwalk, may be adapted with a guardrail to protect observers, may include a stairway and/or elevator for access to the observation area/deck, and/or may be constructed of resilient materials so as to accommodate up to several dozen concurrent observers, safely and unobtrusively so as not to interfere with training scenarios/exercises being conducted. In an exemplary embodiment, the ceiling of the exemplary reconfigurable training area and/or box enclosure may be open, clear, or of a transparent material, or at least clear or transparent in at least one direction, to enable, e.g., overhead observation, from the observation area, from the deck, or viewing area, of training exercises being conducted in the training area. In one exemplary embodiment, a one directional minor may facilitate viewing of training exercises without interference with training exercises.

In another exemplary aspect, participants in training exercises can prepare for activities in separate, but collocated, mission planning and/or gear/equipment storage areas.

In an exemplary embodiment, equipment may be stored in an organized fashion on, e.g., but not limited to, vertical shelving, accessible by, e.g., but not limited to, a fork lift for ease of reconfiguration and accessibility.

In an exemplary embodiment, the exemplary training facility may be used to provide, e.g., but not limited to, training, counterproliferation training; anti-terrorism training; counter-terrorism training; armed forces training; sensitive site exploitation (SSE) training; forensic collection (FC) training; chemical, biological, radiological, nuclear, and/or explosive (CBRNE) anti-proliferation training; counter proliferation of nuclear, biological, and chemical (NBC) terrorism training; department of defense (DoD) training; intelligence community (IC) training; chemical, biological, radiological, nuclear, and/or explosives (CBRNE) equipment inspection training; forensics gathering training; national security training; homeland security training; law enforcement training; special operations training; police department training; fire department training; hazardous material handling training; intelligence operations training; and/or military operations training.

In an exemplary embodiment, variable lighting may be provided to allow for training in limited light.

In an exemplary embodiment, a sensing device such as, e.g., but not limited to, a sensor, a camera, such as, e.g., but not limited to, video and/or audio capture, storage and/or transmission and communications networking/cabling, infrared (IR) sensor, night vision, low light, darkness sensor, etc. may be placed within the training facilities to enable concurrent and/or later review of training exercises.

In an exemplary embodiment, moveable walls may be reoriented in an expeditious manner to allow for continually new experiences, and realistic simulated, non-static, environments.

In an exemplary embodiment, realistic props may be included in training rooms or areas, to enhance realism of training exercises.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of an exemplary interior perspective of an exemplary main floor of an exemplary training complex according to exemplary embodiment of the present invention;

FIG. 2 depicts an exemplary embodiment of an exemplary interior perspective of an exemplary second floor of an exemplary training complex according to an exemplary embodiment of the present invention;

FIG. 3A depicts an exemplary embodiment of an exemplary photographic view of an exemplary box of an exemplary training area without moveable walls and/or equipment yet being placed therein, according to an exemplary embodiment of the present invention;

FIG. 3B depicts an exemplary observation deck according to an exemplary embodiment of the present invention;

FIG. 4 depicts an exemplary embodiment of an alternative exemplary raised floor which may be constructed to allow floor mounted, but recessed, telephonic wiring, computer network wiring, electrical power and/or outlets, cold and/or hot, water supply and/or conduits, and/or waste water drains, etc.;

FIG. 5A depicts an exemplary embodiment illustrating an exemplary construction of an exemplary standard movable wall according to an exemplary embodiment of the present invention;

FIG. 5B depicts an exemplary embodiment illustrating an exemplary construction of an exemplary standard wall section for a door and/or an exemplary wall section, and an exemplary wall with an exemplary window according to an exemplary embodiment of the present invention;

FIG. 6 depicts an exemplary embodiment of a recessed electrical outlet in an exemplary false bottom floor and an exemplary wall section connection process for exemplary walls outfitted with exemplary conduit, wiring, electrical outlets, water, and/or waste water drains;

FIG. 7 depicts an exemplary embodiment of a typical exemplary wall assembly according to an exemplary embodiment of the present invention;

FIG. 8 depicts an exemplary embodiment of a photographic view of a fully constructed exemplary training area complete with moveable internal walls and populated with exemplary moveable equipment according to the present invention;

FIGS. 9A and 9B (collectively 9) depict an exemplary embodiment photographic top view of an exemplary floor plan of an exemplary section of an exemplary completed training area that has been populated with exemplary equipment and/or props for an exemplary training event;

FIG. 10 depicts an exemplary embodiment of an exemplary photographic top view of an exemplary section of an exemplary completed training area that has been populated with exemplary equipment and exemplary props for an exemplary exercise scenario;

FIG. 11A and 11B depict an exemplary embodiment of an exemplary photographic top view and bottom view, respectively, of an exemplary constructed observation platform (catwalk) for observing exemplary training exercises from above, according to the present invention;

FIG. 12 depicts an exemplary embodiment of an example of a potential layout and placement of exemplary permanent and/or semi-permanent, exemplary video cameras to record training and exercise activities in the training area according to the present invention;

FIGS. 13A and 13B (collectively 13) depict an exemplary embodiment of a photographic view of an exemplary single camera mounted to a constructed observation deck and an exemplary single camera mounted directly to the wall, both positioned to record an exemplary section of the exemplary training area according to an exemplary embodiment of the present invention;

FIG. 14 depicts an exemplary embodiment illustrating an exemplary skills development station area for increasing CBRNE scientific understanding according to an exemplary embodiment of the present invention;

FIG. 15A depicts an exemplary embodiment of an exemplary photographic view of exemplary, simulated, non-toxic CBRNE stimulants including an exemplary fabricated exterior and food safe contents bearing close representation to the simulated product according to an exemplary embodiment of the present invention;

FIG. 15B depicts an exemplary embodiment of a photographic view of exemplary fabricated labels used for non-toxic CBRNE stimulants bearing close representation and/or resemblance to the simulated product according to an exemplary embodiment of the present invention;

FIG. 15C depicts an exemplary embodiment of a photographic view of exemplary non-toxic CBRNE stimulants including an exemplary fabricated exterior and food safe contents being integrated into an exemplary training scenario according to an exemplary embodiment of the present invention;

FIG. 16 depicts an exemplary embodiment of a photographic view of a portion of an exemplary constructed training area showing exemplary furnishings and exemplary moveable elements outfitted with exemplary casters and wheels, and props of an exemplary scenario where an exemplary simulated chemical weapon was being made according to an exemplary embodiment of the present invention;

FIG. 17 depicts an exemplary embodiment of a photographic view of an exemplary portion of an exemplary constructed training area showing exemplary furnishings, exemplary moveable elements, and props of an exemplary training scenario where an exemplary simulated biological weapon was being made clandestinely in an exemplary pharmaceutical research company according to an exemplary embodiment of the present invention;

FIG. 18 depicts an exemplary embodiment of an exemplary photographic view of various exemplary props obtained and/or custom fabricated that would be of operational, intelligence, and/or evidentiary value that would be intentionally placed in a target and would be part of an exemplary scripted scenario leading to an exemplary larger WMD program and/or other exemplary ongoing or supporting efforts according to an exemplary scenario of an exemplary embodiment of the present invention;

FIG. 19 depicts an exemplary embodiment of an exemplary design and layout of an exemplary equipment storage area including exemplary vertical shelving according to an exemplary embodiment of the present invention;

FIG. 20 depicts an exemplary embodiment of an exemplary photographic front view of an exemplary constructed equipment storage area filled with exemplary required equipment and supplies according to an exemplary embodiment of the present invention;

FIG. 21 depicts an exemplary embodiment of an exemplary design and exemplary layout of an exemplary team mission planning, preparation, and/or recovery area according to an exemplary embodiment of the present invention;

FIGS. 22A and 22B (collectively 22) depict an exemplary embodiment of an exemplary ground-level photographic view of an exemplary constructed team room complex and exemplary stairway to an exemplary second floor, according to an exemplary embodiment of the present invention; and

FIG. 23 depicts an exemplary embodiment of an exemplary photographic front view of an exemplary constructed team equipment storage area according to an exemplary embodiment of the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and/or configurations can be used without parting from the spirit and scope of the invention.

An exemplary embodiment of the present invention is generally directed to a

Sensitive Site Exploitation (SSE) and Forensic Collection Training Facility for use in training and preparing persons and teams to conduct SSE operations and/or operations to collect intelligence and/or forensic evidence. More specifically, the exemplary embodiment of the present in relates to an integrated Sensitive Site Exploitation (SSE) & Forensic Collection Training Facility, which, in an exemplary embodiment, may include a complete system of capabilities, which may include a reconfigurable training and mission rehearsal area, equipment supply and logistics area, training/exercise participant staging and preparation area, specialized lecture facilities, and/or training support areas, according to an exemplary embodiment. Various terms, as used herein, are defined below. To the extent a term is used in a claim and is not defined below, it should be given the broadest definition persons in the pertinent art have given that term as reflected in printed publications and issued patents. The drawings may be, but are not necessarily, to scale and the proportions of certain parts have been exaggerated to better illustrate details and features described below.

The concept of an exemplary Sensitive Site Exploitation (SSE) and Forensic Collection Training Facility increases the national security of the United States by providing a complete and integrated training center for agencies, organizations, teams, and personnel with the roles and responsibilities to conduct SSE operations and/or operations to collect intelligence and/or forensic evidence. This includes basic SSE operations such as exploiting a residence or apartment through sophisticated SSE operations to exploit CBRNE facilities and combat the use of WMD. In addition, it provides the much needed infrastructure to train personnel and teams to meet the Counterproliferation Program Review Committee (CPRC) recommendation for the U.S. Government to “improve capability to conduct exploitation of WMD sites.” The U.S. Government defines “counterproliferation” as “actions to defeat the threat or use of weapons of mass destruction against the United States, U.S. Armed Forces, its allies, and partners.” The primary focus of the Sensitive Site Exploitation (SSE) and Forensic Collection Training Facility is to support all levels of SSE operations and/or operations to collect intelligence and/or forensic evidence. This also includes counterproliferation missions to exploit WMD sites. However, the unique nature of the facility allows it to support various aspects of missions outside of SSE and counterproliferation including, but not limited to, post-attack crime scene investigation, non-proliferation, consequence management, and site exploitation of CBRNE-related targets without hazardous materials such as terrorist safe houses, weapons caches, warehouses and storage facilities, recruitment and training centers, and fund raising and forgery activities.

A Sensitive Site Exploitation (SSE) & Forensic Collection Training Facility, according to an exemplary embodiment, may serve as a single integrated facility where all, or the majority, of training operations occur and applicable equipment may be stored and used to conduct basic, intermediate, advanced, and sustainment training as well as exercises and mission rehearsals. The ideal facility may be located in one building and may include a specialized training area with exemplary moveable walls allowing for varying floor plans and variable scenarios, observation and evaluation areas, a skills development area, an equipment storage area with a comprehensive inventory of SSE and CBRNE equipment as well as props and other items to simulate various types of foreign and/or domestic operating environments, a student/participant mission preparation/planning and post-mission recovery area, a practical exercise briefing and debriefing area, and training/lecture room(s) according to exemplary embodiments.

While various exemplary embodiments may include all aspects co-located in one building, another aspect may allow for elements to be located in separate areas and/or multiple nearby buildings. For example, equipment storage may be located off-site at a secondary secure location and only the equipment needed for the training area may be brought and stored where practical exercises are being conducted, according to another exemplary embodiment.

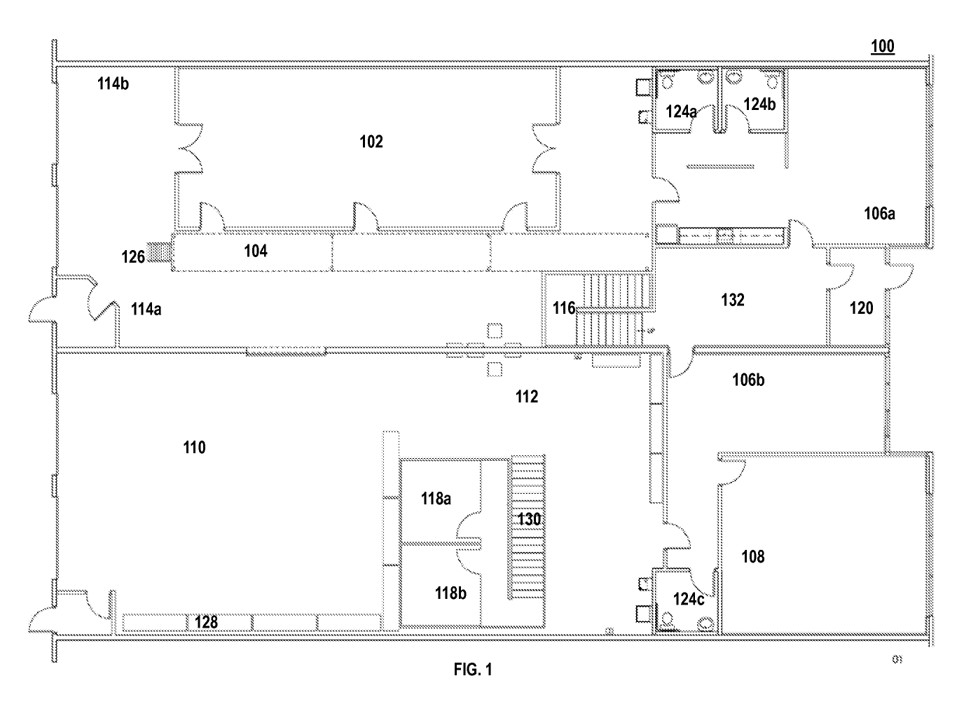

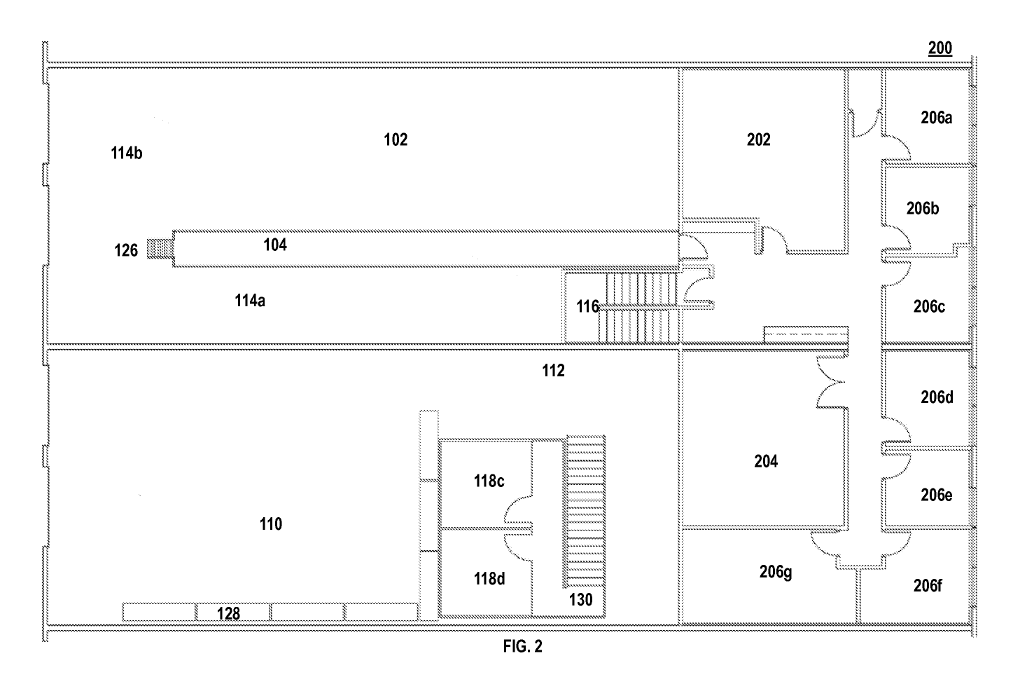

FIGS. 1 and 2 provide exemplary views illustrating one example of an exemplary Sensitive Site Exploitation (SSE) & Forensic Collection Training Facility. This example illustrates an exemplary two-story building with sufficient height for a potential direct view observation station/catwalk directly overlooking the training area.

FIG. 1 illustrates an exemplary first floor with a training area 102 with exemplary moveable walls (not shown), an exemplary equipment storage area 110, an exemplary mission preparation and recovery area 112, and exemplary training room(s) 108.

An exemplary embodiment may include an exemplary first floor as illustrated in FIG. 1, including a secure entrance area 120, a reconfigurable training and mission rehearsal area 102, an observation deck (catwalk) 104 with stairway 126, a training support areas 106a, 106b, specialized lecture facilities 108, equipment supply and logistics area 110, a training/exercise participant staging and preparation area 112, skills training areas 114a, 114b, stairs to a second level 116, training rooms 118a, 118b, stairs to additional training rooms 130, restrooms 124a, 124b, and 124c, and/or training entrance/exit area 132.

According to an exemplary embodiment moveable walls may be configured and/or reconfigured in the reconfigurable training and mission rehearsal area 102, so as to provide non-static, highly realistic, simulated realworld training experiences, in an open top training area 102 which may be observed from the observation deck 104.

FIG. 2 illustrates an exemplary embodiment of an exemplary second floor/exemplary mezzanine floor with a direct observation station/catwalk 104 overlooking reconfigurable training and mission rehearsal area 102, and exemplary additional classroom(s) 202, which in a further and/or alternative exemplary aspect could also be used as indirect observation area with a live video feed from various exemplary cameras overlooking the training area 102. Various specialized training support areas 204, and/or office(s) 206a-g may also be provided in exemplary embodiments. Stairs 130 allow access to training rooms 118c, 118d. Other configurations, including one-story configurations, are available alternatives.

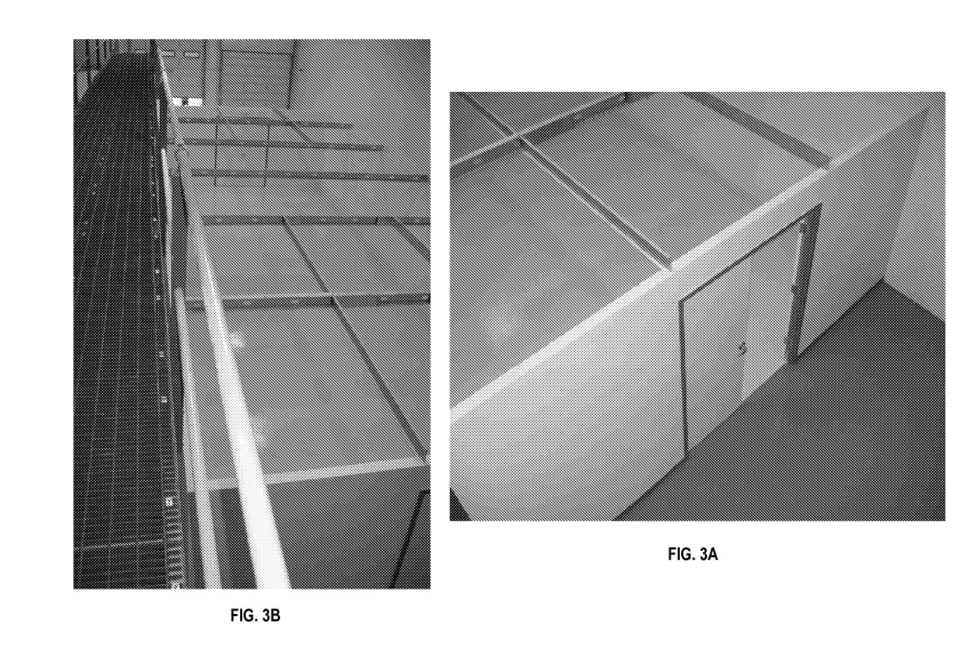

FIGS. 3A and 3B illustrate various top down views of an exemplary training/practical exercise area or box 102, not including moveable walls or equipment, and an observation deck view of the training box 102, respectively, according to exemplary embodiments of the present invention. The exemplary design may allow for the permanent construction of only the outer walls of the training/exercise area which may be stabilized by exemplary overhead crossbeams, as depicted in the exemplary embodiment. According to an exemplary embodiment, there may be no roof on the facility making the training area observable from, e.g., but not limited to, the observation platform/catwalk 104, which may be immediately overlooking all, or a portion of the training area 102, according to an exemplary embodiment. An exemplary embodiment may include electrical outlets which may be built into the permanent walls and may include a non-skid and/or chemical-resistant coating on the floor, according to an exemplary embodiment. The non-skid coating may be used because the floor may become slippery during the conduct of practical exercises as sampling may require decontamination of the sampling containers and personnel onsite which my contribute to water and bleach on the floor, according to an exemplary embodiment.

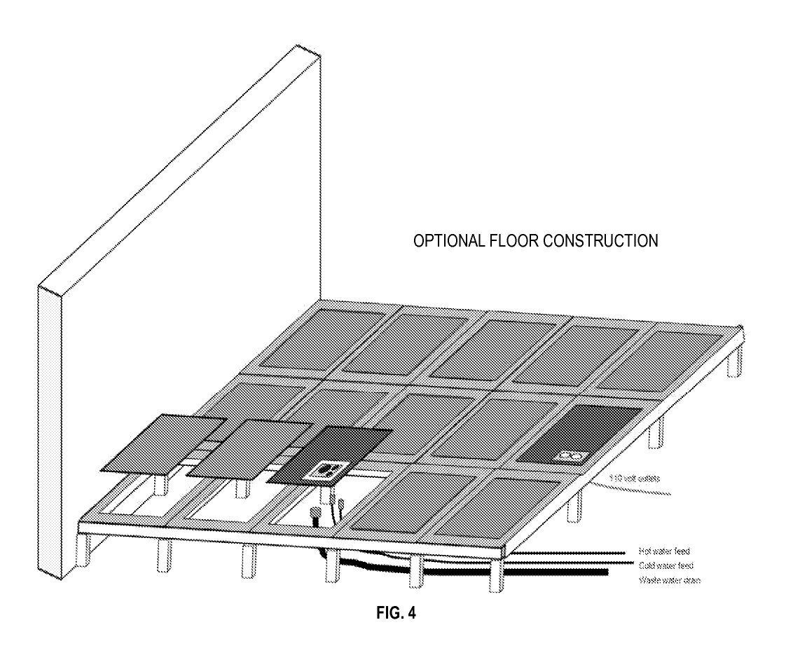

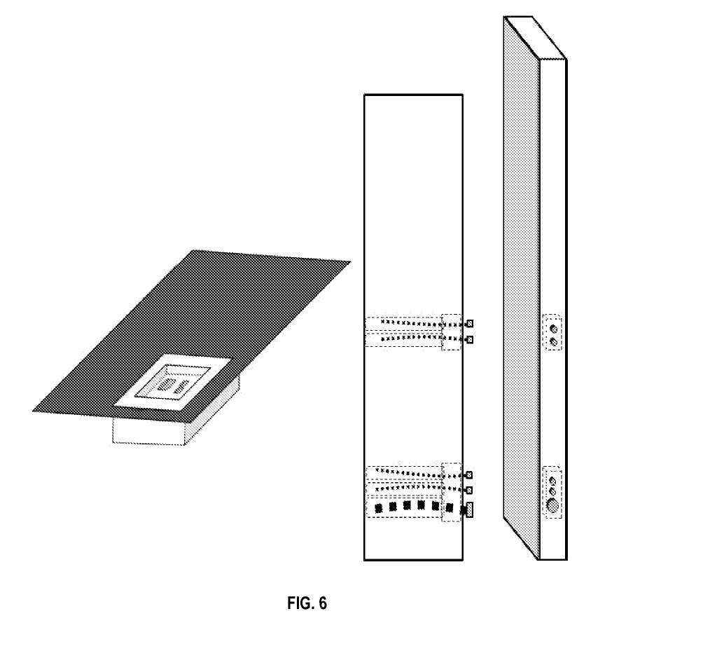

FIG. 4 depicts another exemplary embodiment. In an exemplary embodiment, an optional raised floor can be constructed with exemplary removable floor panels allowing exemplary floor mounted, recessed electrical outlets, water supply, and/or waste water drains at various exemplary selected areas within the exemplary raised floor. An example of this embodiment is shown in FIG. 4 and FIG. 6.

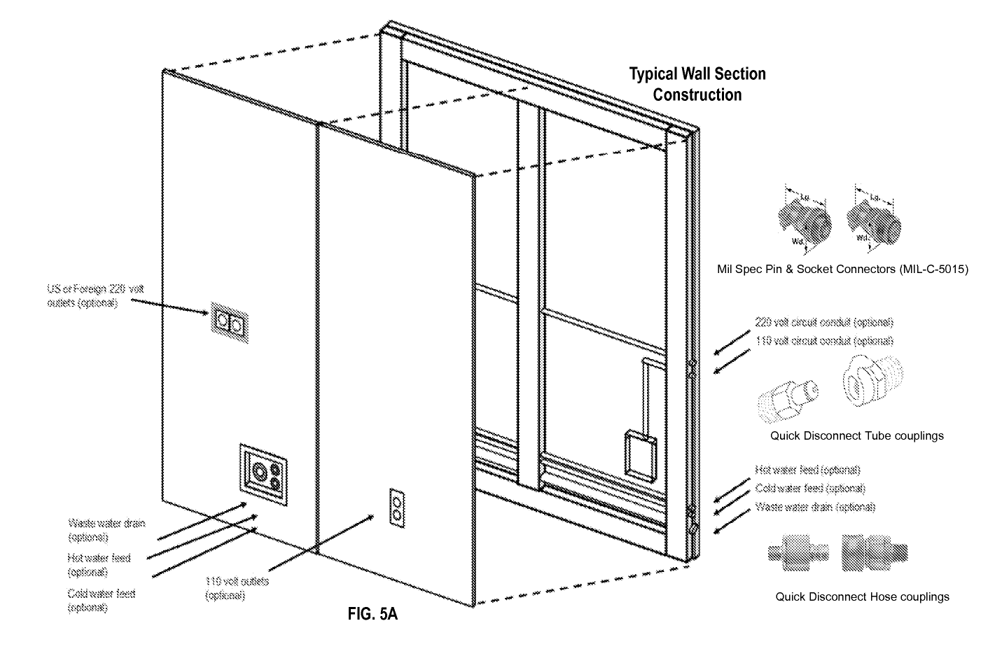

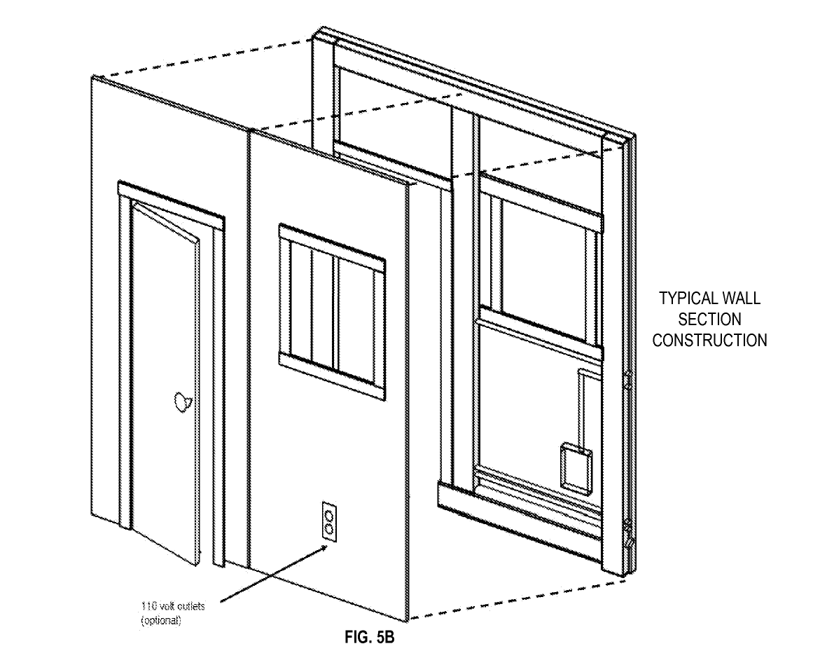

As depicted in FIGS. 5A, 5B and 6, according to an exemplary embodiment, training box 102 may be outfitted with easily reconfigurable floorplans, using various exemplary embodiments of moveable reconfigurable wall panels which may include, e.g., but not limited to, solid walls, walls with windows, walls with doors, walls with electrical, water, networking, communications, or other conduit. To allow for infinitely configurable/reconfigurable floor plans, the training/practical exercise area is populated with moveable wall panels that may allow training personnel and teams to experience multiple varied, non-static scenarios in a short period of time thereby eliminating redundant training environments, improving training value, and ultimately reducing training costs. The exemplary wall panels may come in various exemplary widths, styles, types, orientations and/or heights, which may include, e.g., but are not limited to, plain wall sections, sections with doors, sections with windows, sections containing water connections, sections having electrical connections, sections with multiple utilities, and/or those with airlocks, etc. The exemplary wall panel sections may be interconnected and/or coupled, directly or indirectly, to comprise any desirable floor plan with desirable characteristics in each created room.

FIG. 5A illustrates an exemplary construction of an exemplary typical wall section. FIG. 5B illustrates an exemplary wall panel section for an exemplary door and an exemplary wall panel section for an exemplary wall with an exemplary window. In another exemplary aspect, optional exemplary electrical outlets, conduit, communications lines, networking, telephony, computer, water, and/or water waste drains can be constructed into the wall panel sections and may be connected and/or coupled to other wall panel sections with, e.g., but not limited to, pin & socket connectors and/or quick disconnect couplings as illustrated in the exemplary diagrams of FIGS. 5A and 5B, and FIG. 6.

FIG. 6 depicts an exemplary edge view of an exemplary wall panel, as well as a side view with exemplary dotted line view of exemplary conduit and connectors/couplers indicated at the edge of a respective wall panel, as well as an exemplary top view of an exemplary floor panel, which may include an exemplary raised floor, panel, according to one exemplary embodiment.

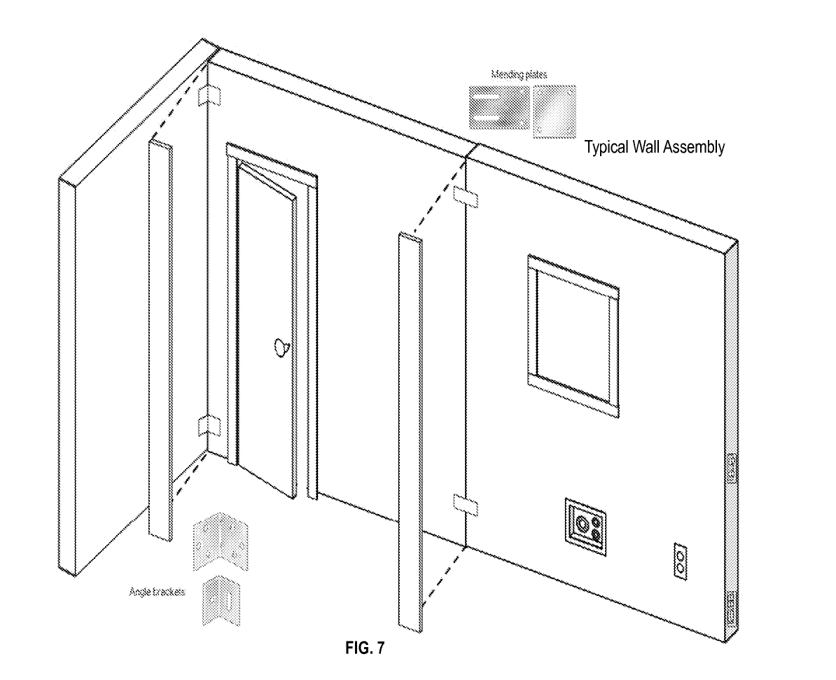

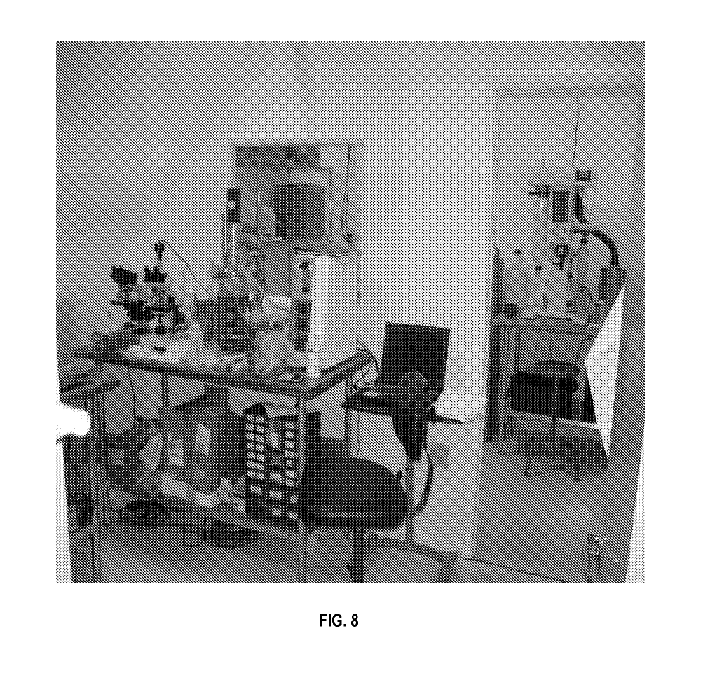

FIG. 7 depicts an exemplary diagram illustrating exemplary wall assembly via exemplary mending plates and exemplary angle brackets, which may be used to couple pairs of exemplary wall panels, according to an exemplary embodiment. Wall sections may be assembled using a combination of angle brackets and mending plates which may be connected or coupled to joining wall sections. In addition, angle brackets and mending plates may be used as necessary to connect to crossbeams for additional support. Once the walls are joined a piece of thin decorative molding may be attached to conceal the joints. This process is illustrated in FIG. 7 and FIG. 8 shows a photograph of several wall sections appropriately assembled so as to depict an exemplary room. Once all the exemplary wall sections have been completed and the floor plan is completed the facility training box 102 may be populated with equipment and props to simulate the planned scenario for a training event, exercise, and/or mission rehearsal.

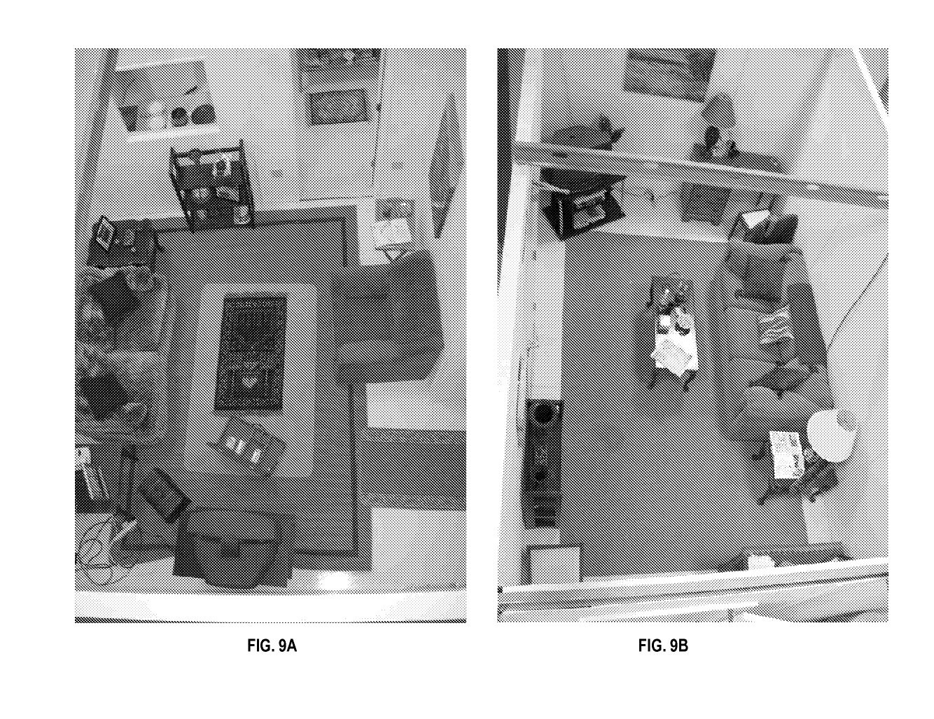

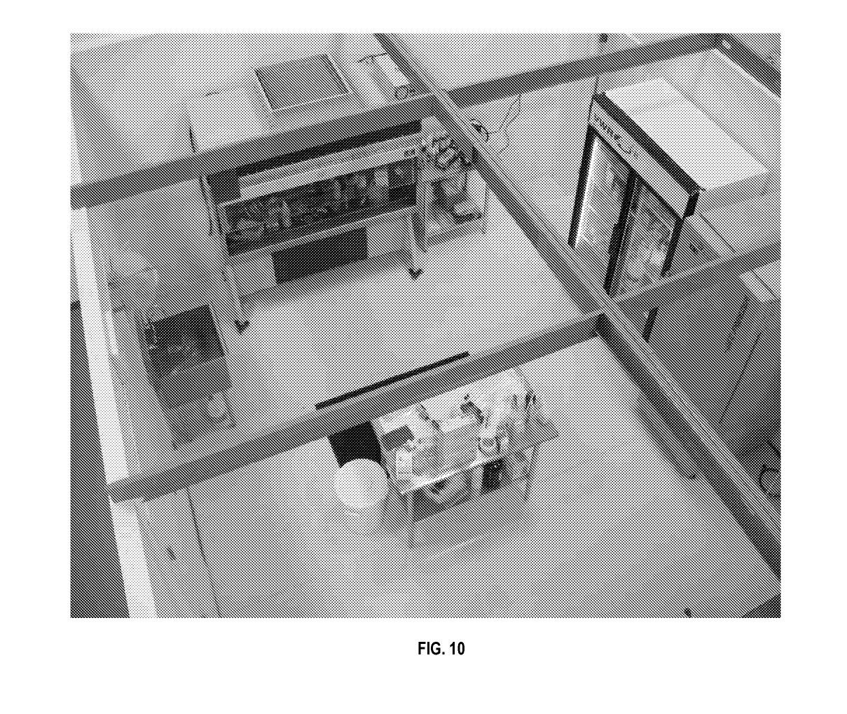

FIGS. 9A, 9B, and 10 show examples of two different exemplary top views of exemplary floor plans that have been populated with equipment and props for training and exercise scenarios.

In yet another aspect, optional lighting control and/or sound systems (not shown) can be added to the training area. Lighting control may allow for students/participants to operate under a variety of lighting conditions such as, e.g., but not limited to, full light, low-light, and no light, etc. Exemplary sound systems can also be added that provide a variety of sounds including, but not limited to, city noises, weather and nature sounds, celebratory gunfire or fierce firefight, calls to prayer or other religious sounds, community sounds (i.e., e.g.,but not limited to, open market, busy business district, etc.), sounds of related but non-present response forces (i.e., e.g., but not limited to, incident command, local police, EMS, etc), and/or white noise, or other distractions, sound effects, etc.

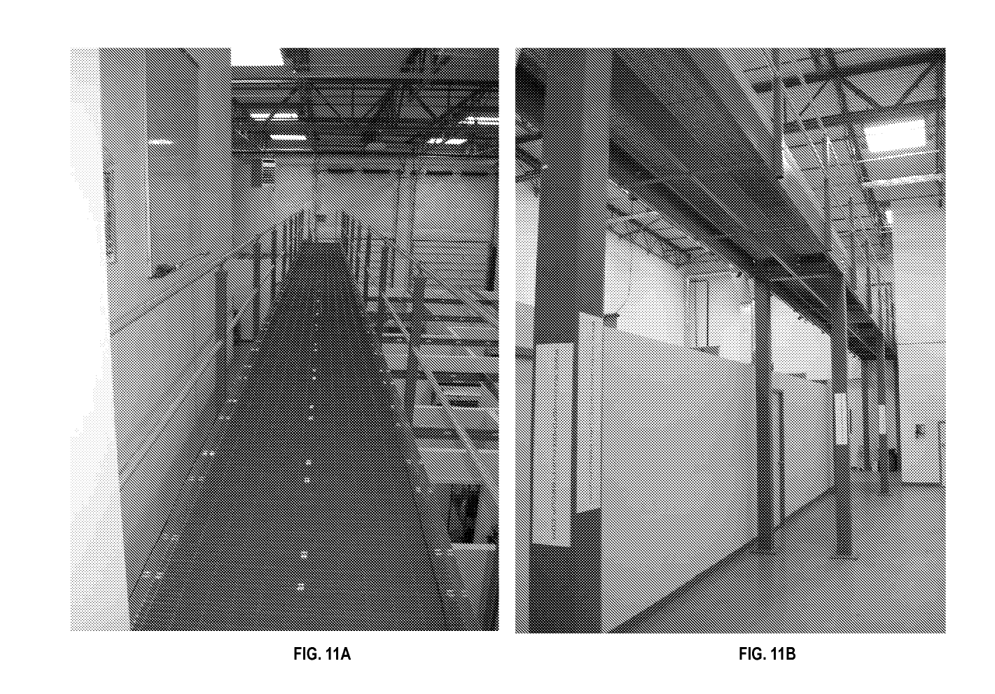

FIG. 11A and 11B depict an exemplary observation deck 104, according to an exemplary embodiment for observing training area 102. An exemplary observation station 104 may provide observers, evaluators, managers, and/or VIPs an opportunity to observe personnel and/or teams without interfering with their training. According to an exemplary embodiment, the direct view observation platform/catwalk 104 may be a primary means by which personnel can observe training or/or preparation activities. The platform 104 may be placed in close proximity to the training area and may be elevated in a manner that may allow personnel on the platform 104 to view directly into the training area 102.

FIG. 11A depicts an exemplary top view of an exemplary constructed observation platform 104 over a partially shown exemplary training area 102. FIG. 11B illustrates how the observation area 104 may be vertically raised above the training area 102 for unobstructed viewing of an open roof, or transparent ceiling of training area 102. In an alternative embodiment a remote observation area 104, 202 could replace the direct view observation platform 104 or supplant or serve as an addition to, or overflow viewing area, of the observation platform 104 providing multiple observation options. In yet another embodiment which can be used independently or in connection with the direct view observation platform 104 and remote observation capability 202, may allow for a series of video cameras, for example, to record the activities of the personnel and teams in the training area 102. These video recording feeds could be viewed remotely, or may be stored for later viewing, and may be accessed, and later viewed and used as a debriefing tool as well as to serve as a venue for personnel to review their performance. The remote observations area may provide video coverage of the training area through a series of cameras which may provide a live-feed of the training area 102 into an exemplary room such as, e.g., but not limited to room 202, which may be located onsite and/or off-site, etc. The ability to record and later view may be beneficial when a narrator is used to explain the activities, it is used as a teaching tool, or active discussions need to occur. Video recording may allow for viewing without the potential of disturbing personnel operating in the training area 102.

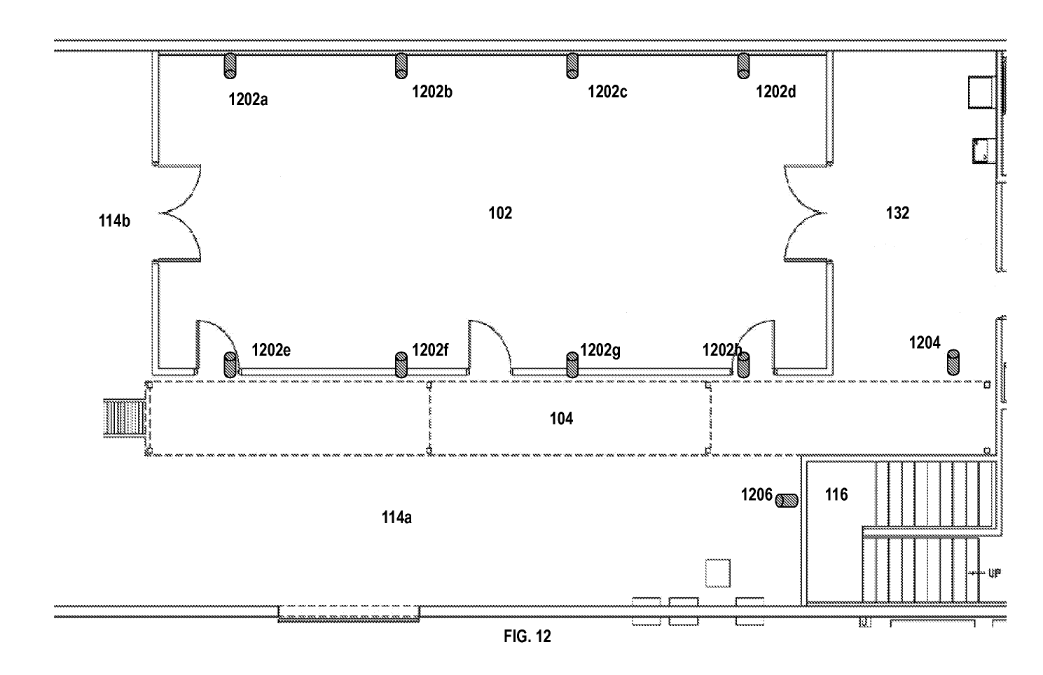

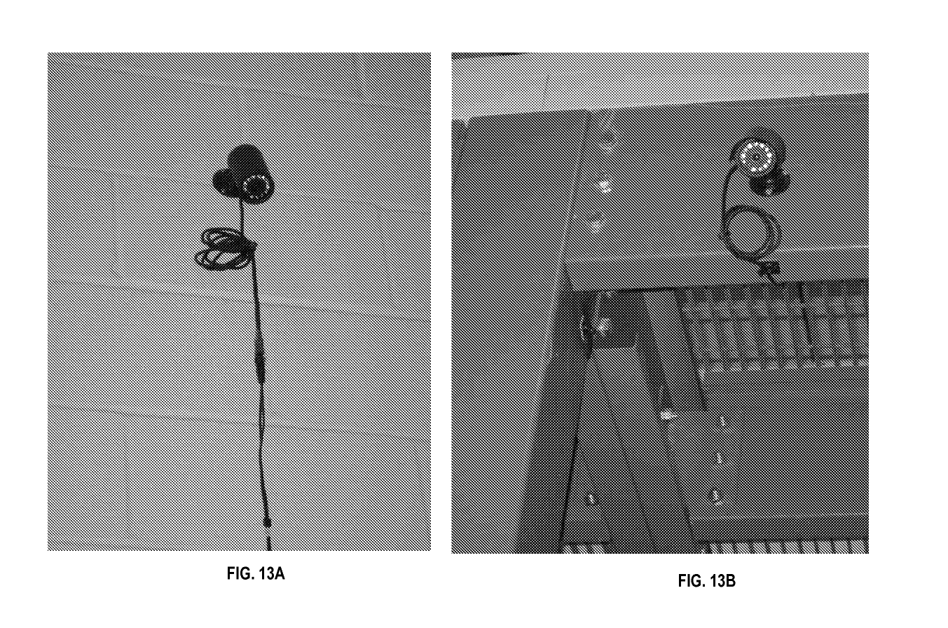

FIG. 12 depicts an exemplary embodiment of a potential exemplary layout of a plurality of cameras 1202a-h, and may include placement of permanent and/or semipermanent video cameras 1202, 1204, 1206 to capture video for an exemplary live-feed to a remote viewing area and/or an exemplary store/record of activities going on in the training room 102, or cameras 1204, 1206 in other areas 114a, 114b, 132, for example.

FIGS. 13A and 13B depict various exemplary images of photographic views of exemplary single cameras mounted to a constructed observation deck and an exemplary single camera mounted to the wall, each positioned to record a section of the training area according to an exemplary embodiment of the present invention. Any useful camera, or video capture device may be employed to capture and/or storage and recordation of video and/or audio footage of exemplary training scenarios, according to exemplary embodiments of the present invention.

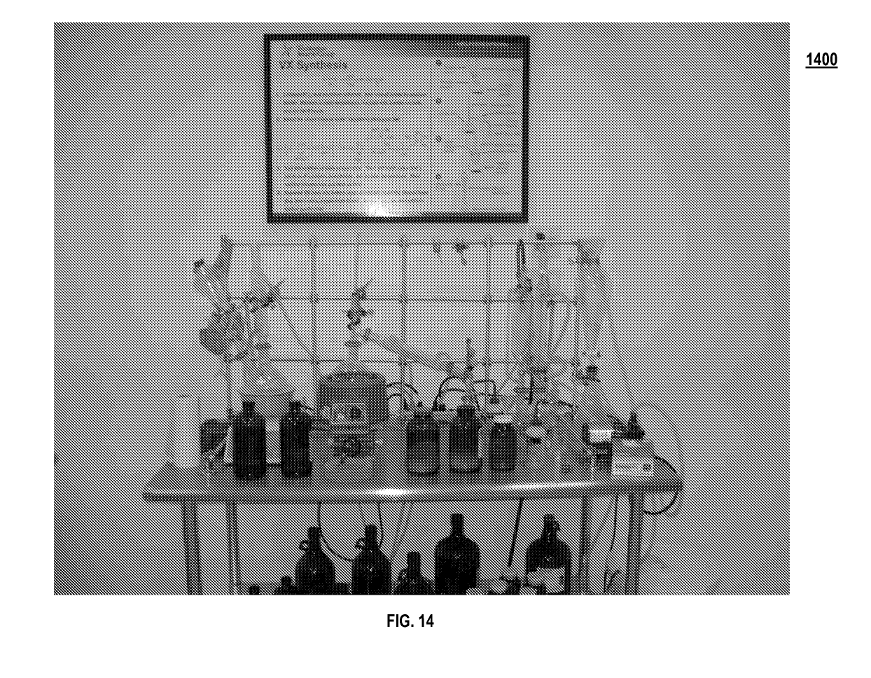

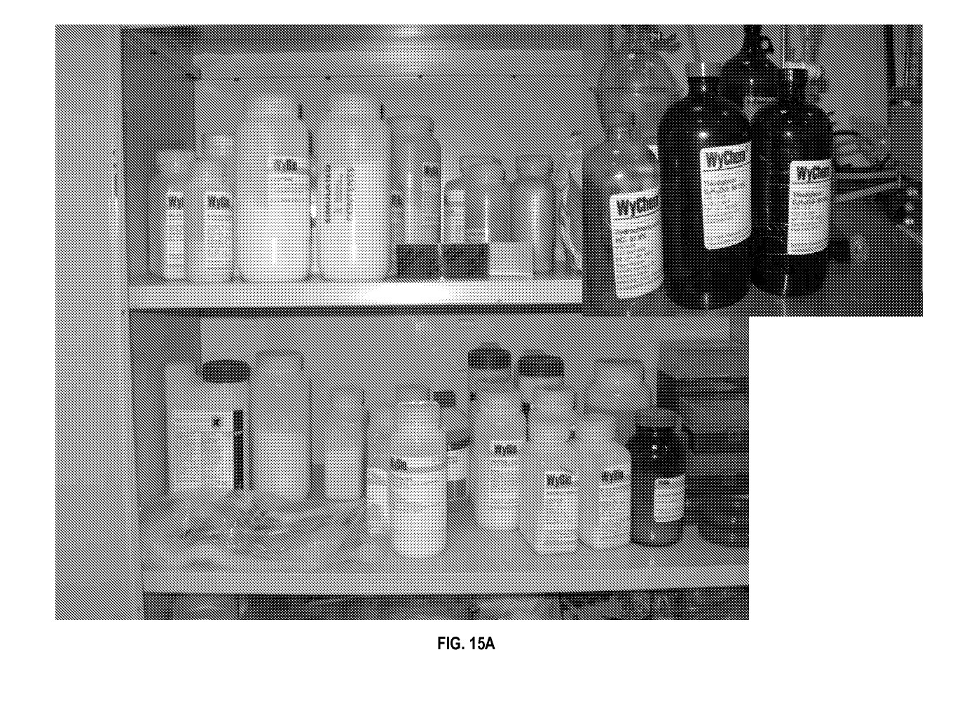

FIG. 14 depicts an exemplary skills development station area 1400 for increasing CBRNE scientific understanding, according to exemplary embodiments of the present invention. A skills development area 1400—may be either permanent or temporary, according to exemplary embodiments—may dramatically increase the capabilities of individuals and teams conducting SSE and/or forensic collection operations, according to exemplary embodiments of the present invention. The skills development area 1400 may be intended to serve as an early stage learning aid that may allow students to practice various tactics, techniques, and/or procedures prior to being put into practical exercises that may integrate various targets, aspects, multiple pieces of equipment, and/or may require the student/participant to make choices based on their initial survey and findings. In addition, students/participants can use the skills development area for sustainment and refresher training. A skills development station 1400 can allow the student to practice one or more procedures for a particular collection or exploitation operation. This practice may include, e.g., but is not limited to, safely manipulating scientific and/or common glassware and/or hardware, sampling and/or collection of chemical and/or biological or other materials, collection of forensic samples (i.e., e.g., but not limited to, latent fingerprints, DNA, gunshot and explosives residue, and collection/storage of biometric signatures etc.), optimization and/or practice of hand-held detection and identification instrumentation, development of internal individual and team communication protocols, understanding operations of certain instrumentation used in CBRNE production, learning common and alternate chemicals and materials used in CBRNE production pathways/methods, evaluation of standard operating procedures, testing of students on established agency/unit procedures, and demonstration of individual capabilities to visitors and VIPs. A skills development station 1400 ideally may have the necessary equipment, protocols and procedures, a briefing on safety issues, common and alternate production materials, and/or a list of applicable detection, collection, or assessment equipment.

According to an exemplary embodiment, equipment and props are necessary to have an effective SSE and/or forensic collection (FC) training, exercise, and mission rehearsal program. A comprehensive equipment and prop inventory may allow for the development of different targets and scenarios, basic through advanced practical exercises, and the means to rehearse on equipment that may be encountered in near-term missions. Equipment required may, e.g., but not limited to, begin with a comprehensive inventory of Chemical, Biological, Radiological, Nuclear, and Explosives (CBRNE) equipment. This may include, e.g., but is not limited to, scientific and laboratory equipment that can be used in, e.g., but not limited to, the research, development, testing, evaluation, and weaponization of CBRNE materials, etc. Generally, the equipment that may be used may represent the entire continuum of production stages and scale-up. The equipment may include equipment of all types, both domestic and foreign equipment, although there may be cases where only one or the other may be used. Generally, the CBRNE equipment to be used may be fully functional; however, there may be exceptions when non-functional or partially functional equipment may work or may be required based on the particular training scenario. Fully functional equipment may require the students/participants to demonstrate a working knowledge of that equipment and may allow evaluators and safety personnel to judge the student/participant's ability to negotiate the devices especially if the student/participants, or training exercises, have areas of concern such as, e.g., but not limited to, mechanical movement, pressure, heat, etc.

Since this is a training facility, to ensure safety, in an exemplary embodiment, actual

CBRNE products are not used. Instead, according to an exemplary embodiment, food-safe and/or non-toxic CBRNE stimulants may be used. The materials used in exemplary scenarios may include, e.g., but not limited to, simulated chemicals, chemical agents, biological growth media, biological agents, and/or other related materials, etc. Both the product packaging and the package contents may be developed and provided in a manner that accurately resemble the true simulated product. Data contained on the packages may be enough to allow a student/participant to judge physical characteristics and provide identity to the contents, according to an exemplary embodiment. Often, according to an exemplary embodiment, the label may contain information identical or similar to that found on commercially available materials or that in a material safety data sheet (MSDS). Simulant materials, according to an exemplary embodiment, may be selected and produced to approximate those materials that the simulated materials are replacing in the training scenario and may have similar characteristics as the actual product including, e.g., but not limited to, color, consistency, texture, acidity, viscosity, and/or ability to provide responses from detectors and other equipment.

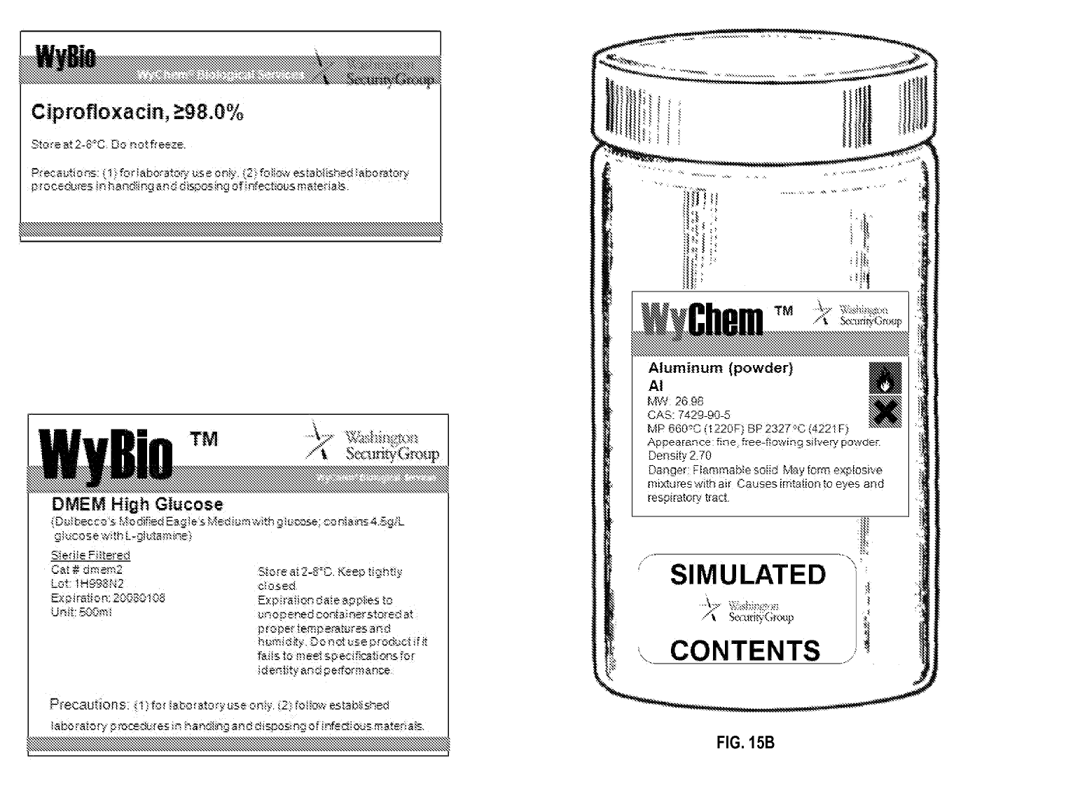

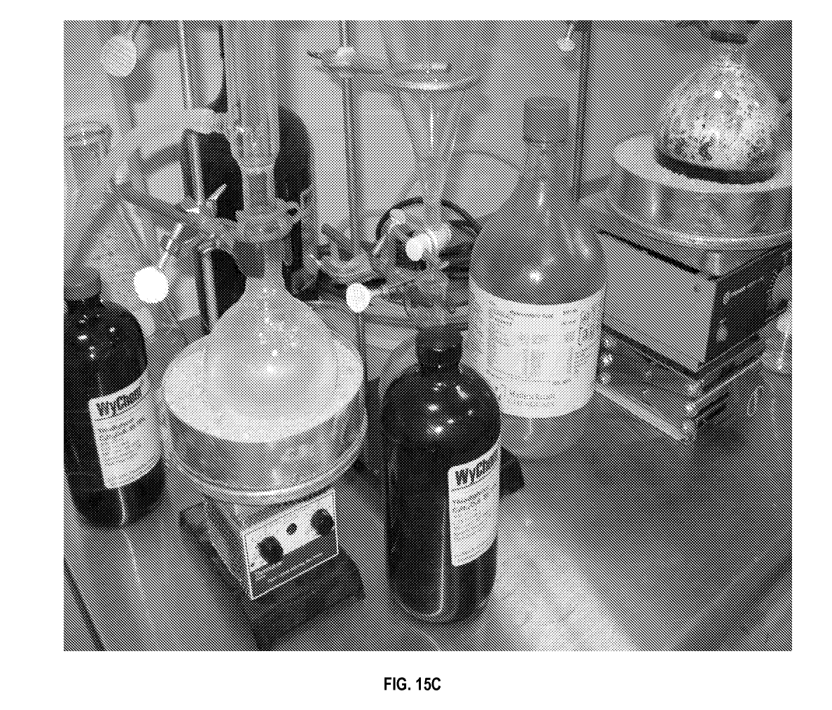

FIG. 15A depicts an exemplary photographic view of non-toxic CBRNE stimulants including a fabricated exterior and food safe contents bearing close representation to the simulated product, according to an exemplary embodiment.

FIG. 15B depicts an exemplary embodiment of fabricated label templates for CBRNE stimulants and FIG. 15C shows an exemplary photographic view of the training stimulants integrated into a training scenario, according to an exemplary embodiment. A full array of props may be required to populate the training area, according to an exemplary embodiment. WMD programs can be conducted by, e.g., but not limited to, state and non-state actors and can be completed in whole or in part at one or more locations, according to an exemplary embodiment. While the WMD programs can be conducted in a traditional laboratory setting, the WMD programs can also be conducted in a clandestine manner in, e.g., but not limited to, offices, industrial sites, apartments/residences, etc., according to an exemplary embodiment. As such a complete inventory of furnishings are necessary for a variety of different scenarios which may include, e.g., but are not limited to, offices, warehouses, residences, hotels, academic institutions, pharmaceutical facilities, chemical plants, and medical and/or veterinary facilities, etc. In addition, props may need to be on hand to populate each of the aforementioned types of facilities and/or environments, according to an exemplary embodiment. The props may include, e.g., but are not limited to organizational items, documents, etc.; personal/life style items; kitchen equipment and utensils, furniture (offices, bedrooms, living rooms, etc.), military props, business props, and/or small miscellaneous items, etc., according to an exemplary embodiment. Additional props may be needed, or provided, to simulate illicit activity and may include, e.g., but not limited to, obvious, discreet, and/or concealed items of operational, intelligence, and/or evidentiary value, etc., according to an exemplary embodiment. Exemplary embodiments of props, and materials to simulate an environment may include, e.g., but are not limited to, shipping documents, invoices, passports, identification cars, credit cards, receipts, schedules, appointments, contact lists, personal or organizational communications equipment, meeting notes, agendas, phone rosters, picture and photographs, artwork, and/or diagrams/sketches/plans, etc., according to an exemplary embodiment.

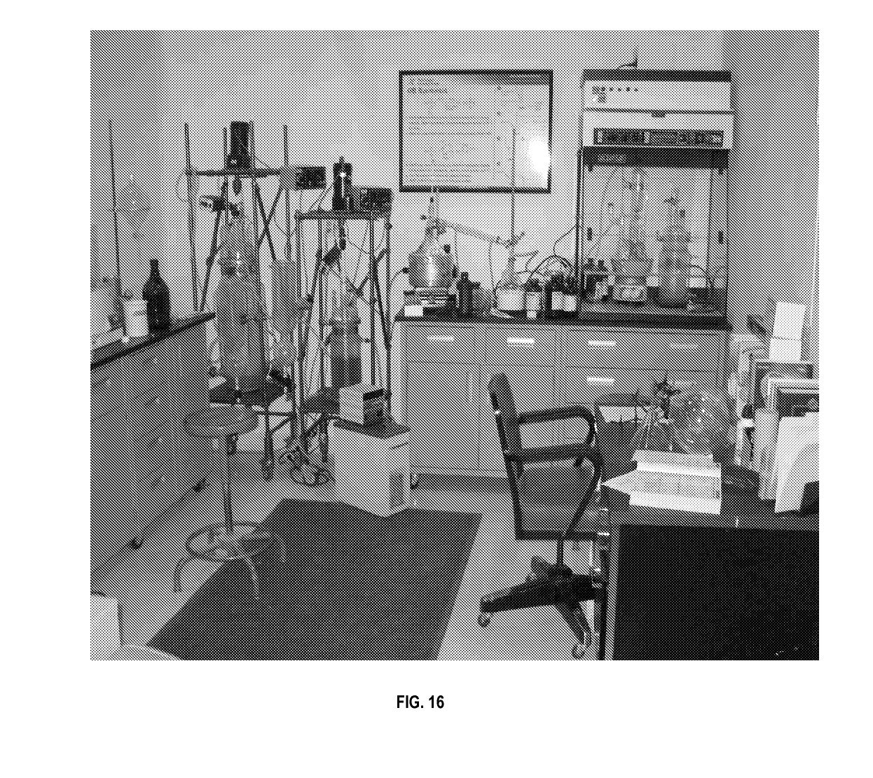

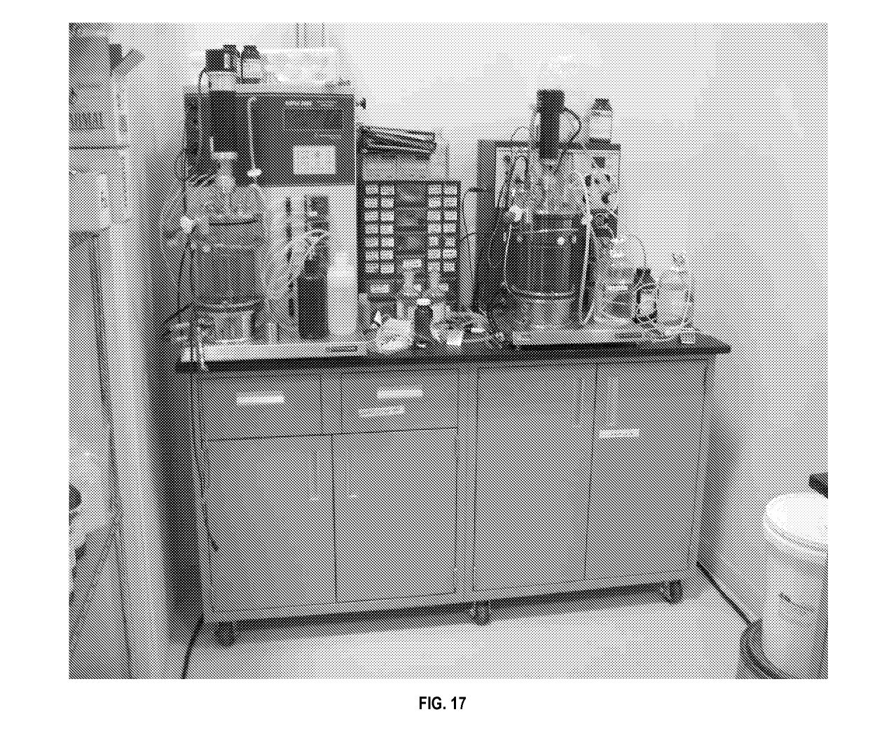

FIG. 16 and FIG. 17 illustrate exemplary photographic views of a portion of constructed training areas showing exemplary, but non-limiting furnishings and exemplary props of two different exemplary scenarios, according to an exemplary embodiment.

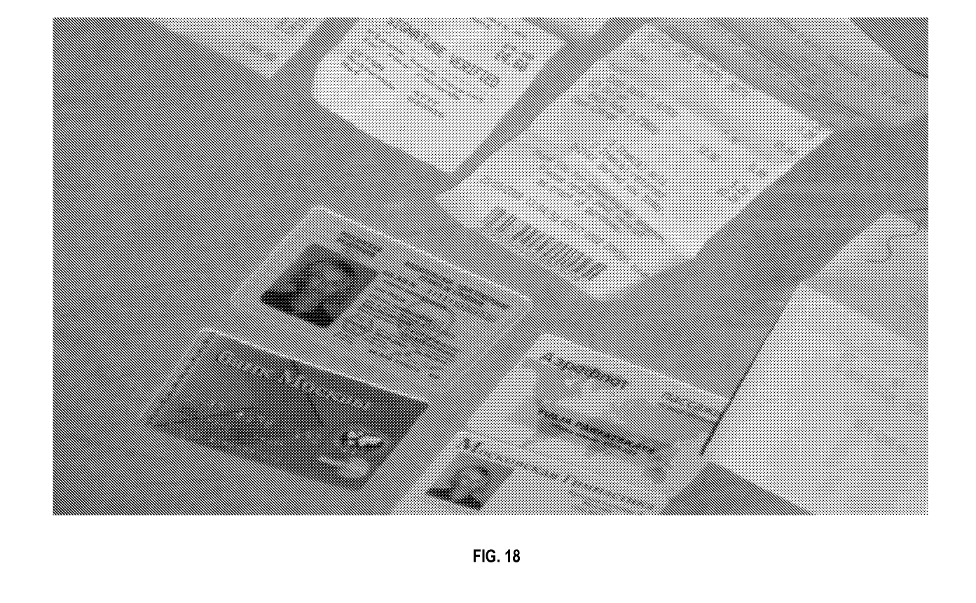

FIG. 18 illustrates various exemplary props that may be used to simulate what are operational, intelligence, and/or evidentiary value that are intentionally placed in a target and are an exemplary part of an exemplary scripted scenario leading to an exemplary larger program and other exemplary ongoing or supporting efforts, according to an exemplary embodiment.

Due to the large amount of equipment and props required for the Sensitive Site Exploitation (SSE) & Forensic Collection Training Facility, according to an exemplary embodiment, a dedicated area 110 may be used, in one exemplary embodiment, to store equipment and materials that are not being used in the training area 102. In addition, an inventory and accountability process may need to be in place to account for the equipment, current location of the equipment, condition of the equipment, and person or group assigned, according to an exemplary embodiment. The equipment itself may be organized and categorized for ease of day-to-day facility management and quick and efficient modifications or changes to the target/training area 102, according to an exemplary embodiment.

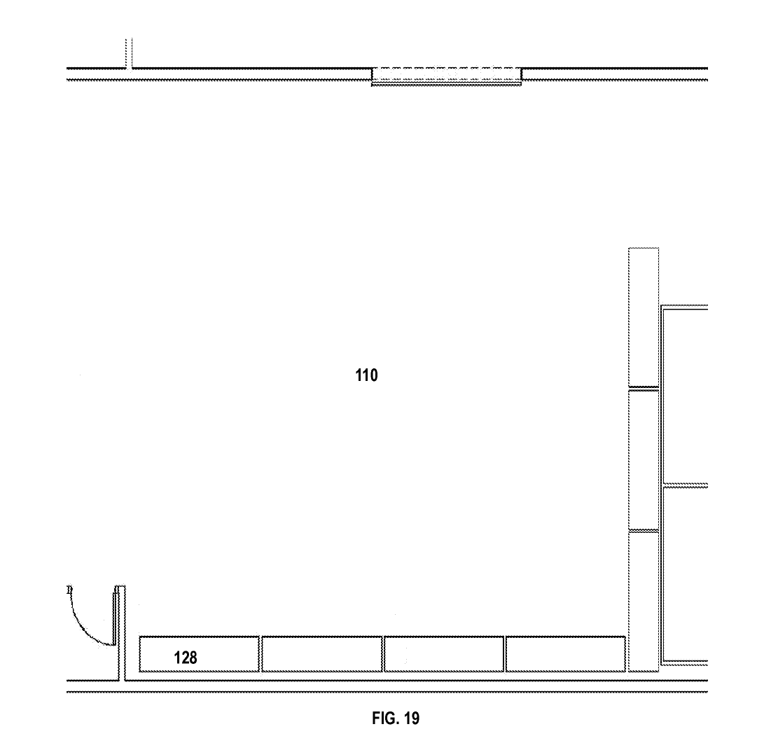

FIG. 19 depicts an exemplary, but non-limiting, design and layout of the equipment storage area 110 including exemplary shelving 128, which may include exemplary vertical shelving 128, according to an exemplary embodiment.

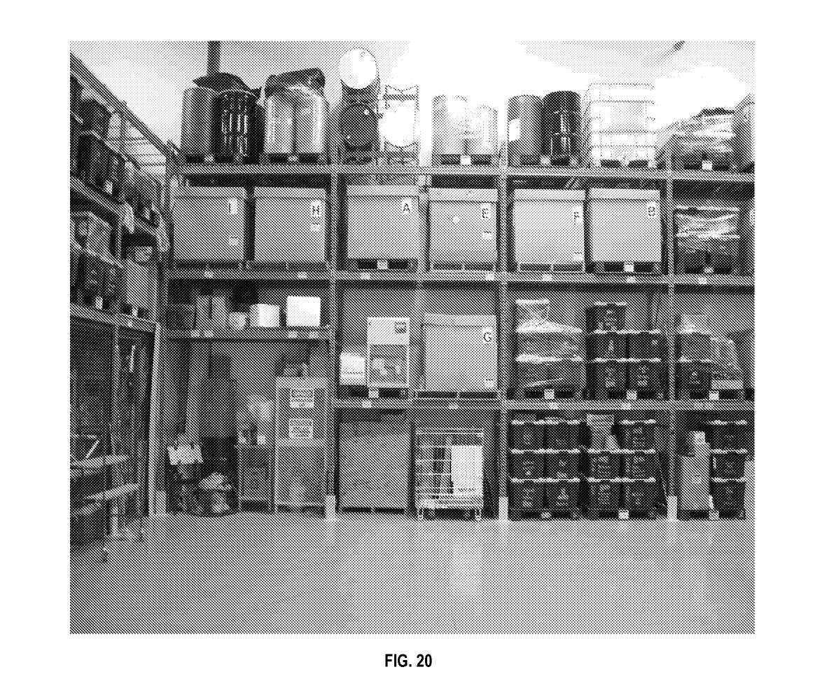

FIG. 20 depicts an exemplary photographic front elevation view of a constructed equipment storage area including exemplary shelving 128, and filled with exemplary equipment and supplies as may be required for setting up exemplary training scenarios for the training area 102. To facilitate rapid movement of, e.g., but not limited to, large pieces of equipment within the facility with limited personnel resources, according to an exemplary embodiment, select pieces of equipment may be custom fabricated and/or modified to include casters/wheels and/or may be modified to support easy movement with a skid system, or conveyer system, or the like. According to an exemplary embodiment, where vertical shelving may be used for storage, various exemplary containers and organizing storage shelving may be used, and may be placed on exemplary wooden or other material pallets, to facilitate movement via an exemplary fork lift, or the like. The reader is directed to the discussion above with reference to FIG. 17 depicting an example of a custom designed laboratory table with wheels adapted for ease of movement.

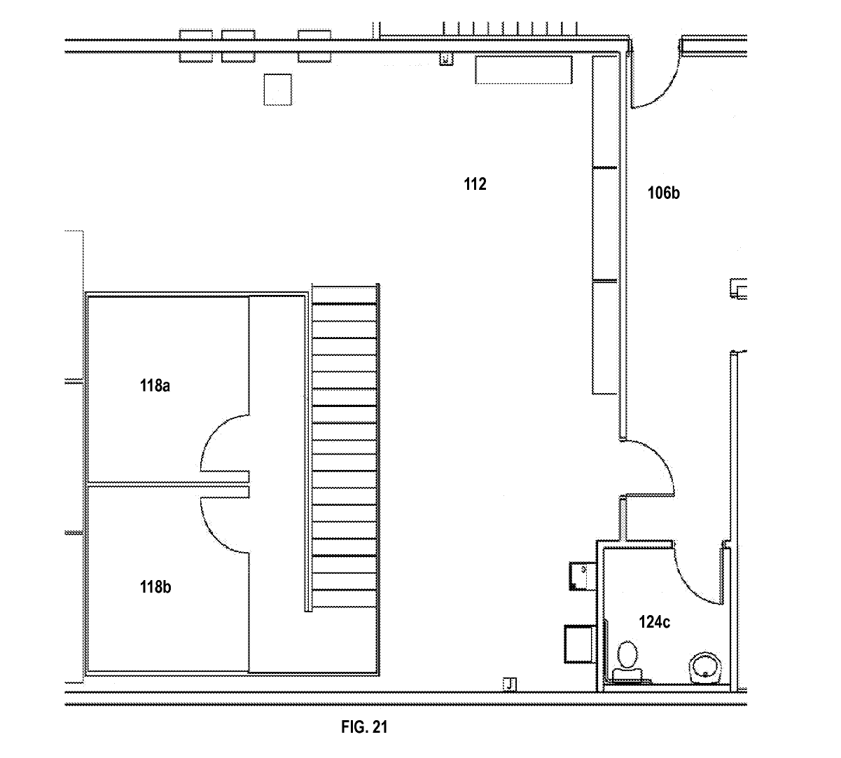

FIG. 21 depicts an exemplary design and layout of an exemplary team mission planning, preparation, and recovery area, according to an exemplary embodiment of the present invention. According to an exemplary embodiment, training rooms 118a, and 118b may be provided and stairs 130 may permit access to additional training rooms, according to an exemplary embodiment of the present invention. Further, areas 112 and/or 106b, among other areas, may be used to organize a team of participants prior to engaging in a training scenario. Provision of restroom facilities 124c, for example, in close proximity to team training rooms allow for ease of access and efficient training with limited time interruptions, according to an exemplary embodiment of the present invention.

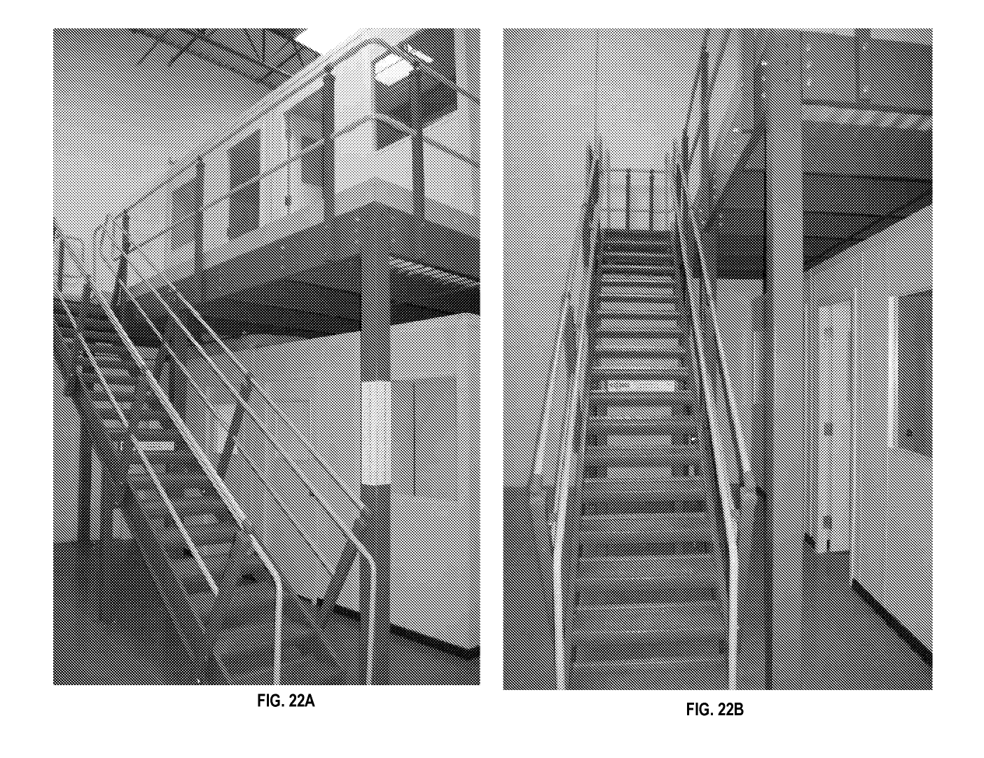

FIGS. 22A and 22B depict a photographic view of a constructed team room complex including an exemplary 2 first floor and exemplary 2 second floor team rooms and exemplary stairs to allow access to upper/mezzanine floor training rooms, according to an exemplary embodiment of the present invention. Exemplary training rooms may be outfitted as shown with doors to minimize noise and to allow multiple exemplary teams to work in dense spaces, while providing privacy, and exemplary windows to allow others to note that a training room is in use, according to an exemplary embodiment of the present invention.

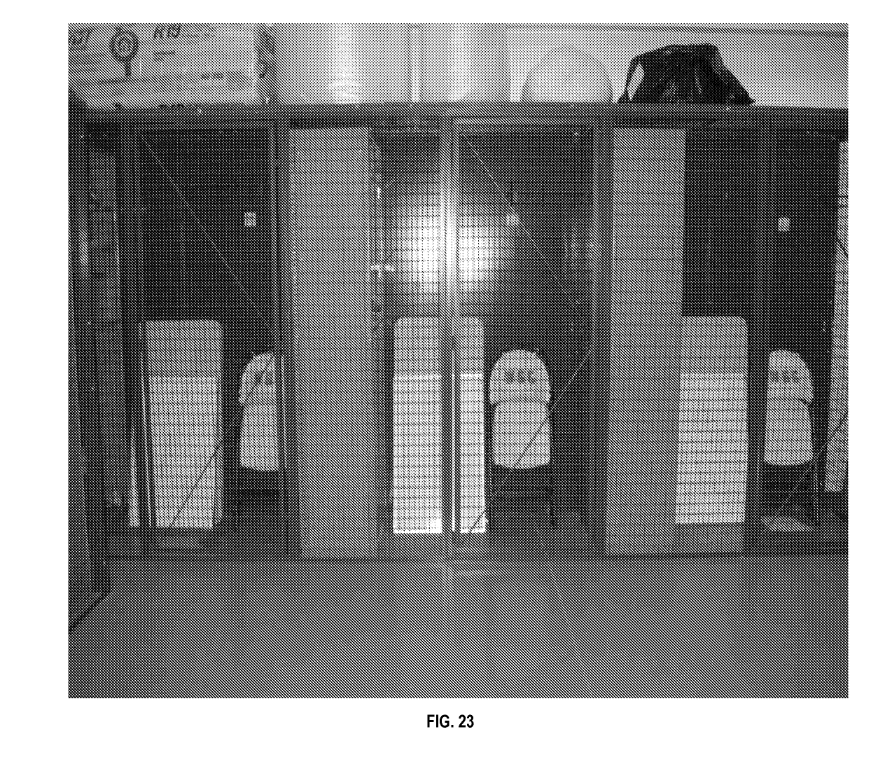

FIG. 23 depicts an exemplary front elevation photographic view of an exemplary constructed team equipment cage/storage area. As part of exemplary preparation, students/participants may review sampling and exploitation protocols of equipment that the students/participants would expect to encounter, according to an exemplary embodiment of the present invention.

To effectively conduct one or more training evolution, exercise, and/or mission rehearsal, personnel and teams, according to an exemplary embodiment of the present invention, may have a dedicated area or areas for mission planning, preparation, and post-mission recovery. Mission planning areas may normally require an office type of environment and may also allow for the use of computers, printers, and sufficient space for reviewing imagery, maps, and other planning data, according to an exemplary embodiment of the present invention. In addition, personnel and teams may have equipment that they may need to conduct pre-mission checks on and in some cases may conduct dry runs of tactics, techniques, and procedures, and may need accommodations for such materials and supplies, according to an exemplary embodiment of the present invention.

According to an exemplary embodiment of the present invention, a minimum of one training/lecture room 108, 202 may be needed to perform didactic instruction in connection with any training program or event, according to an exemplary embodiment of the present invention. This training/lecture room 108, 202 may need to have the essentials related to a classroom including, e.g., but not limited to, tables, chairs, projector, projection screen, and/or a computer, etc., according to an exemplary embodiment of the present invention. While the aforementioned set the exemplary minimum requirements for a training room, another exemplary, perhaps ideal, exemplary training room, may have a number of other features that may improve the learning experience on topics related to, e.g., but not limited to, counterproliferation, forensics, and/or combating WMDs, etc., according to an exemplary embodiment of the present invention.

The first exemplary option may be to include a multi-monitor presentation capability that may add, e.g., but not limited to, additional screens/flat panel televisions to each side of the main projection screen. For example, according to an exemplary embodiment of the present invention, there may be, e.g., but not limited to, a 96″ main projection screen in the center of a wall, and there may be included, a 42″ flat screen television, e.g., on each side of the main projection screen, according to an exemplary embodiment of the present invention. Using, e.g., but not limited to, specialized software, each screen could display, according to an exemplary embodiment of the present invention, the same image/video and/or different images and/or video, and/or audio, etc., according to an exemplary embodiment of the present invention. According to an exemplary embodiment of the present invention, this may improve the learning experience of students/participants, by being able to project or display, e.g., supporting graphs, charts, images, video, warning/safety notices, etc. to the main screen. For example, according to an exemplary embodiment of the present invention, in the area of production nerve agents, the main screen could have, e.g., but not limited to, a combination of text and small graphics, the left-side screen could show a listing of precursor chemicals, and the right-side screen could show example equipment required for the production process being discussed, according to an exemplary embodiment of the present invention.

Another option which could be used independently or in conjunction with the multi-monitor presentation concept, according to an exemplary embodiment of the present invention, may include adding a virtual microscopy capability to the classroom, according to an exemplary embodiment of the present invention. The addition of the virtual microscopy capability, according to an exemplary embodiment of the present invention, may allow the instructor to project images from standard microscopy slides and to display the magnified image onto, e.g., but not limited to, a projection screen and/or television, etc., according to an exemplary embodiment of the present invention.

Yet another option, which can be used independently or in conjunction with the multi-monitor presentation capability, the virtual microscopy capability, or both, is the addition of computers at each student seating location, according to an exemplary embodiment of the present invention. By providing individual student/participant workstations, according to an exemplary embodiment of the present invention, may have multiple benefits. First, presentations or supporting images can run on an exemplary student workstation, in connection with an ongoing brief. The individual student workstation may be beneficial when discussing a number of topics where chemical formulas, technical drawings, photos of equipment, process schematics, or CBRNE recipes may be discussed and a close-up view may be helpful. In addition, having exemplary individual student workstations may allow for quizzes, exams, and/or test to be taken in class and submitted electronically for review and/or grading, according to an exemplary embodiment of the present invention. Finally, for organizations requiring report writing training, the individual student workstation may allow for the instructor to teach via, e.g., the exemplary main screen or screens and the student can follow along conducting an in-class practical examination in real-time, for example, according to an exemplary embodiment of the present invention.

A dedicated training/exercise briefing and debriefing area is highly recommended and may be included in one exemplary embodiment of an exemplary complete Sensitive Site Exploitation (SSE) & Forensic Collection Training Facility, according to an exemplary embodiment of the present invention. The provision of such a dedicated briefing/debriefing area is considered optional, as briefing and debriefing actions could be conducted in the classroom, although conducting such briefings and debriefings in the classroom may hinder other training being conducted simultaneously or in phased fashion, or the like, according to an exemplary embodiment of the present invention. According to an exemplary embodiment of the present invention, a dedicated training/exercise briefing area may include a location where team leaders/members may brief their missions, exploitation plans, etc. to members of the cadre, and/or exercise participants may brief their plans to role-players that may be acting in a leadership capacity, according to an exemplary embodiment of the present invention. In an exemplary embodiment, the minimum requirements for an exemplary exercise briefing and debriefing area may be similar to a training room, although the configuration and set-up may be slightly different, according to an exemplary embodiment of the present invention. The exemplary configuration and set-up may include, e.g., but not limited to, tables, chairs, projector, projection screen, and/or a computer, etc., according to an exemplary embodiment of the present invention. However, according to an exemplary embodiment of the present invention, an exemplary and perhaps ideal briefing and debriefing room may take advantage of other elements of the training facility and may include potential options if implemented, according to an exemplary embodiment of the present invention. One option may include having the computers in the mission planning, preparation, and/or post-mission recovery areas, e.g., but not limited to, networked to the briefing/debriefing area, according to an exemplary embodiment of the present invention. The networking of such workstations may increase efficiency as personnel and teams may have direct access to their mission/exercise briefs in the briefing area and may not have to save, transport, and/or upload briefs from, e.g., computer to computer, according to an exemplary embodiment of the present invention. Another option, that can be provided, according to an exemplary embodiment of the present invention, may include, if videography of the training area is conducted, then that data can be fed into the briefing/debriefing area and may be used by, e.g., but not limited to, instructor/evaluators as a debriefing tool when the students are present, according to an exemplary embodiment of the present invention. Finally, if live-feed video is implemented, the briefing/debriefing room can serve as a primary and/or secondary remote viewing/observation area, according to an exemplary embodiment of the present invention.

The present invention may include, in an exemplary embodiment, a Sensitive Site Exploitation (SSE) & Forensic Collection (FC) Training Facility for use by individuals and teams with mission(s) to conduct counterproliferation operations, counter-terrorist operations, intelligence collection operations, and forensic intelligence collection and/or crime scene investigation. According to an exemplary embodiment, the invention may include a Specialized Training, Exercise, and Mission Rehearsal Area, which may include a Training box with overhead mechanical support structure, Multiple entrances (e.g., Multiple single personnel doors, Multiple double-door equipment entrances), Open top for direct viewing (e.g., Observation, Evaluation), Moveable walls, (e.g., Various types including, With/without quick-connect power connections, With/without quick-connect water/sewer connections, With/without Plexiglas windows, With/without doors having permanent and sacrificial lock mechanisms, With/without cat 5e/6 network cabling). According to an exemplary embodiment, the invention may include Epoxy-coated floor with non-slip coating, Paint-sealed walls for sound transmission reduction and maintenance of odors within space, Optional false floor for running power, water, and sewer underneath, (e.g., Quick connect, and Every 4 feet on grid system). According to an exemplary embodiment, the invention may include Electrical outlets, wall every 4 feet (e.g., 220 volt, 110 volt), Water and sewer access every 8 feet (e.g., Heavy doors that simulate true decontamination area, etc., Multiple, large skylights, Remote control room training area darkening shades to simulate low-light or no light scenarios, Remote control audio system with ceiling and wall mounted speakers to simulate building and city noises common to domestic and foreign environments, Debriefing stations, Isolatable from other activities (e.g., Mechanical, lockable, non-transparent garage doors, Pin-coded, auditable personnel doors). According to an exemplary embodiment, the invention may include Observation stations (e.g., Catwalk—direct view, Catwalk—camera monitors mounted on railings with user-modification/choices to see blind areas, Remote viewing with color/IR cameras every 12 feet (e.g, Observation from a separate room, Recording to digital media for future review) According to an exemplary embodiment, the invention may include Equipment and Props such as, e.g., Domestic & Foreign CBRNE scientific equipment (e.g., Functional, Whole CBRNE process from first steps to weaponization and dissemination), Food-safe or non-toxic CBRNE simulants, Office, warehouse, residence, hotel, etc. furnishings, Props (state-level, non-state actor, pharmaceutical facilities, etc.) (e.g., Simulated materials and bottle fabrication) (e.g., Falsified and simulated documents, or Life-style items). According to an exemplary embodiment, the invention may include Larger pieces modified to facilitate rapid, one-person movement from room-to-room or within the facility (e.g., Wheels, Skids, Equipment Storage Area). According to an exemplary embodiment, the invention may include Categorization and organization; Accountability Process; Inventory Process, secure training area for National Security-level training and mission rehearsals. According to an exemplary embodiment, the invention may include Counterproliferation team mission planning and preparation area, which may include a Skills development areas (“workstations”), which may include a Dedicated trainer equipment sets such as the glove box, fermenters, etc. These would not move and would have sampling/exploitation boards associated with them. According to an exemplary embodiment, the invention may include Lab assembly/disassembly skills area, Counterproliferation Reference Library, Curriculum (past, present, future), Reference materials for protective equipment, samplers, detectors, etc., Applicable scientific reference material, Operating manuals for domestic and foreign equipment in the training center as well as equipment that is not, but may be encountered during Counterproliferation missions.

According to an exemplary embodiment, the invention may include Specially configured training rooms, According to an exemplary embodiment, the invention may include, Triple-screen audio-visual support for instructors (intro only—concept and the importance of it in a counter proliferation leaning environment), Monitors built into the desks for an interactive learning experience, report submittal and virtual microscopy According to an exemplary embodiment, the invention may include Kitchen area for long-term learning environment, Team equipment/gear storage, Team equipment/gear lockers, Team planning and isolations rooms, Electronics equipment to support training events, exercises, and mission rehearsals. According to an exemplary embodiment, the invention may include a method of Operating a “Counterproliferation Training and Mission Preparation Facility”, which may include Administration, Logistics and Inventory Control , Check-in/check-out process, electronic, Bar code inventory, Bin/pallet organization, (e.g., Storage by functional area, Storage by subject matter, Storage by item type, Moving walls and equipment, physical/construction process, According to an exemplary embodiment, the invention may include On-demand wall shuffle with new scenario work area within 6 hours.

According to an exemplary embodiment, the invention may include Design process & assembly of the training area “box”, which may include Requirements review (e.g., Student rehearsal/learning requirements, VIP/supervisor monitoring requirements), Major equipment layout design, Wall design, Utilities layout design, Props and furnishings design, Assembly of walls, Assemble major equipment, Assembly of utilities and supporting materials, Assembly of props. According to an exemplary embodiment, the invention may include Implementing WSG proprietary TSE/SSE calculations, which may include Spatial assessment and assumption based on facility floors and (e.g., Survey time requirements, Search time requirements, Cofactors for damaged structure, wearing of CBRNE protective ensembles, presence of persons on sight. According to an exemplary embodiment, the invention may include, data capture of actual training and exercises to add statistical relevance to the TSE/SSE calculation-mission planning process (e.g., maintaining simulated chemicals, OSHA compliance and routine checks).

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for providing training comprising:
a facility for conducting at least one training scenario comprising:
a reconfigurable training area for conducting at least one training scenario.

2. The system of claim 1, wherein said training facility comprises at least one of:
a sensitive site exploitation (SSE); or
a forensic collection training (FCT) facility, and
wherein said at least one training scenario comprises at least one of an SSE or an FC training scenario.

3. The system of claim 1, wherein said training scenario comprises at least one sensitive site exploitation (SSE) and/or a forensic collection (FC) training scenario comprising at least one of:
basic training, initial training, developmental training, intermediate training, advanced training, sustainment training, a mission rehearsal, an exercise, an annual event exercise, a periodic event exercise, a mission, or practice for at least one of individuals or teams comprising at least one mission to conduct comprising at least one of:
counterproliferation operations,
non-proliferation operations,
counter-terrorist operations,
intelligence collection operations,
forensic intelligence collection, or
crime scene investigation.

4. The method according to claim 1, wherein said reconfigurable training area comprises a plurality of walls and is adapted to receive within said reconfigurable training area components comprising at least one of:
an open, transparent, an at least one directionally transparent, viewing portal , window, wall, or ceiling;
a specialized training, exercise, and mission rehearsal area;
a plurality of moveable walls;
at least one prop to add realism;
at least one piece of furniture;
at least one piece of furniture adapted for ease of movement;
at least one piece of laboratory equipment;
at least one scientific instrument;
at least one piece of laboratory equipment modified for ease of movement;
at least one firearms range;
at least one driver track;
at least one building; or
a building comprising at least one of: a shelter, a warehouse, an office building, or a hangar enclosing at least a portion of said reconfigurable training area.

5. The system according to claim 1, further comprising an observation area for observing at least one training scenario. said observation area comprising at least one of:
an observation deck;
an observation ceiling;
an observation wall;
an observation window;
an observation catwalk;
a video and/or audio capture, storage, transmission and/or communications link from at least one video and/or audio device in said training area coupled to at least one of a local or a remote display and/or audio system; or
an observation area at least one of adjacent, above, or permitting viewing of said reconfigurable training area wherein said reconfigurable training area comprises at least one of:
an open, transparent, an at least one directionally transparent, viewing portal, window, wall, or ceiling area allowing for viewing from at least one of said observation area, adjacent, in a location permitting viewing of, or above;
a transparent ceiling, viewing portal, window, or wall allowing for viewing from said at least one of said observation area, adjacent, in a location permitting viewing of, or above; or
an at least one directionally transparent ceiling, viewing portal, window, or wall allowing for viewing from said at least one of said observation area, said adjacent, said location permitting viewing of, or above.

6. The system according to claim 1, further comprising:
an observation area and at least one observation station comprising at least one of:
at least one viewing area;
at least one of a local or a remote viewing or access area to said reconfigurable training area;
at least one window of at least one of said reconfigurable training area, or said observation station;
at least one display, video, or audio device; or
at least one display, video, or audio, computer storage, access, playback, transmission, communications or storage equipment for providing at least one of remote or local viewing and/or listening of said at least one training scenario being conducted in said reconfigurable training area from said at least one observation station.

7. The system according to claim 1, further comprising at least one of:
equipment simulating a training scenario; or
at least one prop comprising at least one of:
a simulated material;
a simulated chemical material;
a simulated biological material;
a simulated radiological material;
a simulated nuclear material; or
a simulated explosive material.

8. The system according to claim 1, further comprising at least one of:
a participant area adapted for at least one of: planning, preparation, or staging;
a training/exercise area adapted for at least one of: briefing or debriefing;
a training support area;
a skills training area;
a restroom;
a specialized lecture facility;
a secure reception area; or
an equipment supply area.

9. The system according to claim 1, further comprising:
an equipment supply area comprising at least one of:
shelving;
vertical shelving;
pallet based storage;
wall panel storage;
furniture; or
props.

10. A system for providing training comprising:
a facility for conducting at least one training scenario comprising:
a nonstatic reconfigurable training area comprising a plurality of walls, said reconfigurable training area adapted to receive within said reconfigurable training area comprises at least one of:
a specialized training, exercise, and mission rehearsal area;
a plurality of moveable walls;
at least one prop to add realism;
at least one piece of furniture adapted for ease of movement;
a partially indoor or a partially outdoor training area;
a building enclosing at least a portion of said reconfigurable training area;
a low light, daylight, night, or powerless/power outage simulated conditions, or
at least one piece of laboratory equipment modified for ease of movement.

11. The system according to claim 10, further comprising:
an observation area comprising at least one of:
an observation deck;
an observation catwalk;
an observation room;
a local or remote display and/or audio system coupled to a video and/or audio communications link from at least one video or audio capture, storage or transmission device or sensor or camera or device or audio device in said reconfigurable training area; or
an observation area separate from said reconfigurable training area wherein said reconfigurable training area comprises at least one of:
an open ceiling, window, viewing portal, or wall allowing for viewing from above, adjacent, or another viewing area;
a transparent window, viewing portal, wall, or ceiling allowing for viewing from above, adjacent, or another viewing area; or
an at least one directionally transparent ceiling, window, viewing portal, or wall allowing for viewing from above, adjacent, or another viewing area.

12. The system according to claim 10, further comprising:
an observation area comprising at least one of an open, a transparent, a one directionally transparent, or partially transparent viewing access portal, wall, window, or ceiling,an observation station comprising at least one of:
a viewing area;
an area above an open, transparent, partially transparent, or one directionally transparent wall, window, viewing portal, or ceiling of said reconfigurable training area;
a window to said reconfigurable training area; or
a video display and/or audio system for providing at least one of capture, storage, transmission, access, communication, playback and/or local or remote viewing and/or listening from said observation station of said at least one training scenario being conducted in said observation station.

13. A method of providing training comprising:
providing for simulated at least one of a sensitive site exploitation (SSE) or forensic collection (FC) training scenarios comprising:
providing a reconfigurable training area;
providing a plurality of reconfigurable wall panels adapted to be arranged in said reconfigurable training area; and
providing at least one moveable element in said reconfigurable training area.

14. The method of claim 13, further comprising:
providing an observation area for observing said at least one training scenario being conducted in said reconfigurable training area;
providing an open, transparent, or partially transparent in at least one direction wall, window, viewing portal, or ceiling at least one of over, adjacent or for viewing of said reconfigurable training area; and
providing an observation deck or station as part of said observation area at least one of overlooking or in view of said reconfigurable training area.

15. The method of claim 14, wherein said providing said observation area comprises at least one of:
providing a display and/or audio system coupled to at least one of: a captured, a stored, a communicated, and/or a transmitted video and/or audio content or stream, or providing a live and/or stored video and/or audio content and/or stream from at least one video device and/or sensor and/or camera and/or audio system in said reconfigurable training area.

16. The method of claim 13, further comprising at least one of:
providing at least one prop;
providing at least one simulated material;
providing at least one simulated chemical material;
providing at least one simulated biological material;
providing at least one simulated radiological material;
providing at least one simulated nuclear material; or
providing at least one simulated explosive material.

17. The method of claim 13, further comprising at least one of:
providing an equipment supply area comprising at least one of:
providing shelving;
providing vertical shelving;
providing pallet based storage;
providing wall panel storage;
providing furniture; or
providing at least one prop;
providing at least one training room;
providing at least one lecture room;
providing at least one restroom facility;
providing secure access to the facility; or
providing team equipment storage.

18. The method of claim 13, further comprising at least one of:
providing at least one or a plurality of monitors for an instructor; or
providing individual participant workstations comprising at least one of at least one computer, at least one networked computer, at least one computer display, at least one input device, or at least one output device.

19. The method of claim 13, further comprising at least one of:
providing individual participant workstations;
providing individual student computers;
providing networked student computers;
providing computer based examinations on said individual participant workstations; or
providing networked individual participant workstations.

20. The method of claim 13, further comprising:
providing a raised floor in said reconfigurable training area.
